(19) United States
(12) Patent Application Publication
(10) Pub. No.: US 2026/0350296 A1
(43) Pub. Date: Nov. 5, 2026

(54) AN ITERATIVE AND COUPLED PUBLICATION METHOD AND SYSTEM

(71) Applicant: EOCEANS RESEARCH AND CONSULTING INC, Dartmouth (CA)

(72) Inventor: Christine Ann Ward-Paige, Dartmouth (CA)

(73) Assignee: EOCEANS RESEARCH AND CONSULTING INC, Dartmouth, NS (CA)

(21) Appl. No.: 19/488,618

(22) PCT Filed: Apr. 23, 2024
(86) PCT No.: PCT/CA2024/050531

§ 371 Date: Nov. 27, 2025

Related U.S. Application Data
(60) Provisional application No. 63/504,745, filed on May 28, 2023.

(30) Foreign Application Priority Data
Apr. 23, 2024 (WO) PCT/CA2024/050531

(51) Int. Cl. G06F 40/166; G06F 16/23; G06F 16/28

(52) U.S. Cl. CPC G06F 40/166; G06F 16/23; G06F 16/288

(57) ABSTRACT

An iterative publication method and system that connects data-based projects with publication is provided. An administrator logs into a computer system and creates a publication, specifying collaborators, contributors, data sources, analyses, visualizations, and more. Once a project is activated, the system generates written or pictorial elements of the publication(s). The publication has several relational and compound relational elements embedded within it's written or pictorial elements e.g. text, graphs, values, charts, and other similar data. The iterative publication system and method identifies the relational and compound relational elements, and updates these elements within the publication, as and when new data, or observations, or written or pictorial elements become available, thus providing a continually updating publication.

### CROSS REFERENCE TO RELATED APPLICATIONS

The present application claims the priority benefits of International Patent Application No. PCT/CA2024/050531, filed on Apr. 23, 2024, and claims benefit of U.S. Provisional Patent Application No. 63/504,745, filed on May 28, 2023, which are hereby incorporated herein by reference in their entireties.

### FIELD OF THE INVENTION

The present invention relates generally to coupling data projects with publication in an iterative way. More particularly, the present invention relates to a method and publication system that couples a data-based project in tandem with its publication, resulting in a continually updating publication which updates as and when new information becomes available in the data-based project.

### BACKGROUND OF THE INVENTION

With the increasing need for speed and/or transparency in knowledge and the dissemination of data-based information, it is becoming important to speed up the generation and traceability of publications. The world is rapidly changing, and when publications are out of date or misunderstood, they can slow discoveries, enable misinformation and mistrust, and misguide decisions.

Decisions that use data-based publications can include but are not limited to natural science, life science, health science, political science, social science, engineering, economics, spatial planning, health directives, pollution mitigation, policy, journalism, public spending, business and economic decisions, and other areas.

The data-publication process is well established and largely unchanged since at least the 17th century. It generally follows a linear process that includes observation/question, research the topic area, hypothesis, collect and process data, analyze data, interpret results, form the story, and then prepare a document that describes the findings/conclusions.

Documents may be published for others to view in various forms, such as gray literature, reports, working papers, documents, peer-reviewed scientific papers, news articles, magazines, and other documents known to the art. These can be distributed in many ways, such as in hardcopy, paper, soft copy, digital form, online only, Portable Document Format (PDF), or other services known to the art.

Publishers may review, accept, and distribute ‘publications’ in various forms, such as paper, hardcopy, digital, PDF, pay-per-view, subscription, and other forms. Publications shared by publishers are available for reading, decision making, citation, and other purposes, and remain largely unchanged after the publication is published.

A plurality of authors, such as researchers, scientists, doctors, economists, investigators, technicians, journalists, and others may preprint or release their documents, such as on bioRxiv or arXiv or other pre-print or blogging services known to the art, before and/or during the review process for a plurality of reasons, such as to get early feedback and or to distribute the findings sooner than waiting for review, acceptance, and publication by a publisher.

A plurality of platforms are used to post, share, and distribute pre-prints and publications in a plurality of ways, including on publisher's websites, authors and organization websites, blogs, social media platforms like ResearchGate, Google Scholar, and other sites known to the art.

Data systems, software, computing, analysis, and publications can now be provided as a service remotely through the Internet. User data, profiles, scientific data, analysis, and publications, and a plurality of other information, are now stored in the “cloud” using services such as Amazon web services, Azure, Google Cloud, publisher's websites, or other services known in the art.

Many tools are now available to collect, store, access, quality control, process, analyze, and display data and insights that use data. Data may be collected through handwritten notes, sensors and other hardware, eyewitness accounts and interviews, hardware-software interfaces, human-hardware interfaces, mobile applications, and more. Data may be digitized, standardized, recorded, stored and accessed in spreadsheets and databases like Microsoft® Excel®, Microsoft® Access®, Google Sheets, Google Maps, and other digital forms for storing data. Data may be queried, accessed, quality controlled, analyzed, and displayed in software packages such as Microsoft® Excel®, SAS, MATLAB, R, Tableau, various GIS tools, and other data processing, analysis, and display softwares. Many data warehouses, data repositories, and data lakes, such as Google BigQuery, Oracle, OBIS, GEBCO, AWS Data Exchange, and others, store data for access under different copyright licenses, such as open source, freely available, for non-commercial uses, and more. Various Application Programming Interfaces (APIs) are readily available to pipe data and information from and to different computers, servers, interfaces, users, and more.

Authors and contributors who collect data and prepare documents for publication can now deploy many tools to improve workflow efficiency. Documents may be prepared using word processors such as Microsoft Word, Google Docs, and other text processors; documents can be automatically formatted with embedded figures and other analyses outputs such as with LaTeX, R Markdown, and other document processing systems; documents may automatically connect to external references to streamline reference management and literature citations with reference management systems such as EndNote, Paperpile, and other bibliographic reference systems; documents may be collaboratively produced using document creators such as Google Docs, Google Sheets, Dropbox and other online processors that enable a plurality of users to work on a document; data may be processed using statistical software that utilizes programming language to efficiently and repeatedly analyze data and generate repeatable maps, figures, and other outputs such as R, SAS, MATLAB and other programming systems; documents may be shared in news, reports, gray and peer-reviewed literature that can be searched for, downloaded, shared, and cited using software, database, and indexing systems such as ResearchGate, Google, Google Scholar, Web of Science, and other systems.

Publishers now deploy many tools to increase efficiency of producing and sharing publications. Templates may be made available through the Internet for authors to manually input parts of a document to generate consistent formatting (e.g., author gate-ways, dashboards); authors and contributors may be assigned and connected with unique alphanumeric codes to identify and connect individuals with their documents and affiliated organizations such as ORCID, Scopus ID, Google Scholar, LinkedIn; external, internal, and peer-to-peer reviewers may receive and annotate documents and provide publication recommendations (e.g., acceptance, revision, rejection) through Internet based forms, dashboards, and other methods and systems; documents and publications may be stored, displayed, searched, and retrieved using content management, retrieval systems, and social networking sites such as Scopus®, ResearchGate, Google Scholar, BioRxiv, The Conversation, Google News, FaceBook, LinkedIn, and other systems that store, index, search and display documents and publications; reference management systems such as EndNote, Paperpile, and others may be used to efficiently distribute and index references; and persistent identifiers, uniform resource locator (url's), or handles may be used to uniquely identify various authors, organizations, documents, publications, and references for ease of searching and viewing.

The issue with the current publication system is that data-based projects are performed in a linear, static, and opaque way that is separate from the publication process, which leads to delayed discoveries and decision making, errors, mistrust, and/or a plurality of other problems.

The data collection, processing, analysis, story writing and formatting happens, and then, subsequently it may be published if a publisher accepts the story. Publications rarely change after publication except to correct, clarify, or retract. Otherwise, the publication may be used as is, even years to decades after publication if no newer studies have been published.

For example, an author in 2024 may write a news, magazine, blog, or scientific journal article about the global state of coral reefs. They may cite a paper from 2017 that declares that 20% of coral reefs have been lost globally. The data within that published paper may be from 2015 or even earlier because the data review, analysis, acceptance and publication process is long with many steps before publication. Thus, as of 2024, these data are nine years out of date at the time of citation and do not reflect the current global state of coral reefs, even though it may still be the most comprehensive and recent paper published on the topic.

Another issue with today's publication system is that publishers may only be interested in publishing studies on certain topics or those that they deem will be most eye-catching for the public. This can lead to delayed publication of important data and a lack of follow up studies being published once the original research is disseminated to the public. This sort of system greatly hampers scientific progress and decisions in a variety of fields based on current publication systems.

### SUMMARY OF THE INVENTION

According to one aspect of the invention, an iterative and coupled system is provided. The iterative system provides a unique platform to a user, an administrator or a project creator to generate a continually updating publication. The iterative system comprises an authentication server, a profile server, and a content server and a data processing server. The authentication server may comprise a user data module and a user authentication module. The profile server may comprise a user profile module, an administrator profile module, and a reviewer/editor profile module. The content server may comprise a user content module, external content module, a publication creator interface, a data input filter interface, and a data selection filter interface. The data processing server may comprise an iterative data identifier module, a source identifier module, a publication editor module, and a publication generator module.

Another aspect of the invention relates to an iterative and coupled publication method for generating a continually updating publication. The method generally comprises a step of selecting project/publication requirements provided on the publication creator (or publication creator interface) of the iterative system. This is followed by a step of incorporating the user dataset (i.e. users own data or observations) using the data input filter of the iterative system and one or more external dataset(s) are selected using the data selection filter of the iterative system. Once these datasets are incorporated, the relational/compound relational elements embedded within the user dataset or the one or more external datasets are identified by the iterative data identifier. Once the relational/compound relational elements are identified, the written or pictorial elements of the publication are generated. The written or pictorial elements of the publication are continually updated when any relational element or the compound relational element of the written element, pictorial element, user data or the external data are updated.

According to one aspect, there is a method of creating an administrator(s) pro-file(s) and a project, comprising providing information to populate the project requirements, such as collaborator(s), contributor(s), sponsor(s), affiliation(s), methods, hypothesis(es), data collection strategies, analysis types, results display, and a plurality of other information to set up the project.

According to another aspect, data sources to be used by the project may be selected, sourced, curated, validated, etc. and may then feed the analysis, results, and other aspects of the publication.

The system may have connections to various external datasets and diverse ways of inputting data. According to one aspect, sources and contents of external datasets may be varied. These data sources may include historical datasets, existing contemporary datasets, autonomous data collection sensors and sources, user input from mobile devices, application programming interfaces (APIs), and other data input sources known to the art.

Another aspect is an administrator(s) display, where project information is provided, stored, and data analyses and results can be viewed, reviewed, and/or modified. Another aspect is that the method and system allows for a plurality of projects and publications to be contributed to and managed.

According to one aspect, the data may be checked for validity and errors, and then may be reviewed by an algorithm, an artificial intelligent system or a human administrator(s) to confirm acceptance into the project.

According to another aspect, the data may be analyzed via any number of statistical and computer programming tools, and the results may be displayed in the publication.

In another aspect, the administrator(s) has access to interpret the results generated and may populate the written or pictorial elements of the publication, they may also utilize Artificial Intelligence (AI), such as ChatGPT, or any algorithm, to produce the written or pictorial elements.

According to another aspect, the system allows for data input to be ongoing and in tandem with other aspects of the project development, which continually updates the results shown in the administrator(s) display and the publication.

In another aspect, the system, administrator(s), consumer(s) or user(s), or a combination thereof, may prompt a third-party review, which may be a plurality of review types and may be of parts or the whole publication.

Another aspect allows the administrator(s) to act on reviews and revise the publication to reflect updated results and understanding, until such time that the project is inactive or archived.

In another aspect, administrator(s) and consumer(s) or user(s) may have a plurality of roles and responsibilities in a project, including but not limited to project administrator(s), creator(s), contributor(s), funder(s), sponsor(s), and a plurality of other roles and they may each work on the project in a plurality of ways. In another aspect, administrator(s) and consumer(s) may trace the results and displays back to the data sources.

### BRIEF DESCRIPTION OF THE DRAWINGS

The invention will now be described, by way of example only, with reference to the attached Figures, wherein:

FIG. 1A. shows a high-level hardware architecture of a system that may be used to implement various aspects;

FIG. 1B. shows a high-level architecture of the various servers (120, 121, 122, 123) shown in FIG. 1A;

FIG. 2. shows a flow chart demonstrating a project-publication method and system;

FIG. 3. shows a flow chart demonstrating a project creator method and system;

FIG. 4. shows a flow chart demonstrating an input and filter method and system;

FIG. 5. shows a flow chart demonstrating an analysis and results display method and system;

FIG. 6. shows a flow chart demonstrating an administrator(s) interpretation and discussion method and system;

FIG. 7. shows a flow chart demonstrating a project-publication status method and system; and

FIG. 8. shows a flow chart demonstrating the continually updating publication method.

### DESCRIPTION OF THE PREFERRED EMBODIMENTS

The following description is of preferred embodiments by way of example only and without limitation to the combination of features necessary for carrying the invention into effect.

All terms are intended to be understood as they would be understood by a person skilled in the art. Unless defined otherwise, all technical and scientific terms used herein have the same meaning as commonly understood by one of ordinary skill in the art to which the disclosure pertains. The section headings used herein are for organizational purposes only and are not to be construed as limiting the subject matter described.

Although various features of the present disclosure can be described in the context of a single embodiment, the features can also be provided separately or in any suitable combination. Conversely, although the present disclosure can be described herein in the context of separate embodiments for clarity, the present disclosure can also be implemented in a single embodiment.

The following definitions supplement those in the art and are directed to the current application. Accordingly, the terminology used herein is for the purpose of describing particular embodiments only and is not intended to be limiting.

### Definitions

In this application, the use of the singular includes the plural unless specifically stated otherwise. It must be noted that, as used in the specification, the singular forms “a,” “an” and “the” include plural referents unless the context clearly dictates otherwise.

In this application, the use of “or” means “and/or” unless stated otherwise. The terms “and/or” and “any combination thereof and their grammatical equivalents as used herein, can be used interchangeably. These terms can convey that any and all combinations are specifically contemplated. The term “or” can be used conjunctively or disjunctively, unless the context specifically refers to a disjunctive use.

Furthermore, use of the term “including” as well as other forms, such as “include”, “includes,” and “included,” is not limiting.

Reference in the specification to “some embodiments,” “an embodiment,” “one embodiment” “alternate embodiment”, or “other embodiments” means that a particular feature, structure, or characteristic described in connection with the embodiments is included in at least some embodiments, but not necessarily all embodiments, of the present disclosures.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps. It is contemplated that any embodiment discussed in this specification can be implemented with respect to any method or composition of the present disclosure, and vice versa. Furthermore, compositions of the present disclosure can be used to achieve methods of the present disclosure.

The term “about” in relation to a reference numerical value and its grammatical equivalents as used herein can include the numerical value itself and a range of values plus or minus 10% from that numerical value. The term “about” or “approximately” means within an acceptable error range for the particular value as determined by one of ordinary skill in the art, which will depend in part on how the value is measured or determined, i.e., the limitations of the measurement system. For example, “about” can mean within 1 or more than 1 standard deviation, per the practice in the art. Alternatively, “about” can mean a range of up to 20%, up to 10%, up to 5%, or up to 1% of a given value. In another example, the amount “about 10” includes 10 and any amounts from 9 to 11.

### Embodiments

The invention will now be described by means of the following exemplary embodiments. A person skilled in the art would understand that the embodiments and examples provided merely describe the nature of the invention and any embodiment or example not specifically recited still falls within the scope of this invention.

In an embodiment of the invention an iterative system is provided. The iterative system allows a user or an administrator or a project creator to generate a continually updating publication. The administrator in some embodiments could be an algorithm, an artificial intelligent system, a human administration or a combination of any of them. The iterative system comprises an authentication server, a profile server, and a content server and a data processing server. The authentication server may comprise a user data module and a user authentication module. The profile server may comprise a user profile module, an administrator profile module, and a reviewer/editor profile module. The content server may comprise a user content module, external content module, a publication creator interface, a data input filter interface, and a data selection filter interface. The data processing server may comprise an iterative data identifier module, a source identifier module, a publication editor module, and a publication generator module.

In an embodiment of the invention, the iterative system to generate a continually updating publication includes several components. For instance, the iterative system has a publication creator that populates a publication interface with a plurality of publication requirements. The plurality of publication requirements could be selected from publication format, publication font, publication style, publication length, publication authors, publication editors, publication reviewers, publication sources, user datasets, or external datasets. The iterative system may have a data input filter that allows a user to incorporate their own i.e. a (user dataset), or (user content) in the publication. The iterative system may have a data selection filter that allows the user to incorporate a plurality of external datasets in the publication, for instance research databases, publications, published books, government publications, patent documents, photo libraries, stories, observations, or any publicly or privately available literature. The iterative system further may have an iterative data identifier that identifies a relational element and a compound relational element embedded within the user dataset uploaded by the user or the external datasets accessed by the user. The iterative system may have a publication generator that allows a user to generate the written or pictorial elements or the content of the publication based on the plurality of project or publication requirements defined by the user, based on the user dataset and based on the external dataset. Once the written or pictorial elements of the publication are generated, the iterative data identifier continually updates the written or pictorial elements of the publication. For instance, the iterative data identifier updates the publication when the relational element/compound relational element of the user dataset or the relational element/compound relational element of the external datasets are updated.

In another embodiment, the iterative system may further comprise a publication editor. The publication editor may be an algorithm, an artificial intelligent system or a human administrator. The publication editor reviews, validates, suggests changes or edits the user dataset once incorporated by the user using the data input filter.

In another embodiment, the iterative system may have a publication editor that reviews, validates, or edits the written or pictorial elements of the publication once generated by the publication generator.

A few non-limiting examples of the plurality of publication requirements that can be pre-defined or defined by the user prior to generating a publication could be publication format, publication font, publication style, publication length, publication authors, publication editors, publication reviewers, publication sources, user datasets, other project datasets, or external datasets.

A few non-limiting examples of the plurality of external datasets that can be accessed using the iterative system could be research databases, publications, published books, government publications, patent documents, or any publicly available literature.

A few non-limiting examples of validation include validation by an algorithm, validation by artificial intelligence or by a human administrator. For instance, the plurality of external datasets could be validated by an algorithm or by artificial intelligence before they are pulled in the iterative system. For instance, if an external dataset is known to be inaccurate, a human administrator or AI may decline access to that dataset when a user attempts to use it for his/her publication.

A few non-limiting examples of the written elements of the publication are text, values, results, data or any written content of the publication.

A few non-limiting examples of the pictorial elements of the publication are graphs, maps, diagrams, figures, charts, tables, or any pictorial content.

A few non-limiting examples of the relational elements that could be embedded in a dataset could be values, results, summary statistics, year ranges, study locations, methodologies, citations, figures, text or any other piece of information.

A few non-limiting examples of the compound relational elements that could be embedded in a dataset could be calculations, statistics, suites of values, list of countries or any data used to fill the relational element.

In another embodiment, the iterative system may further comprise a source identifier. The source identifier provides original sourcing information of any relational element, any compound relational element, any written or pictorial elements of the publication, or any portion thereof. Once the source identifier identifies a source of the relational element, the compound relational element, or the written or pictorial elements it generates a sourcing information. This sourcing information is then automatically updated by the source identifier when the source of the relational element, the compound relational element, or the written or pictorial elements changes.

In another embodiment, the processing of a group of nesting publications is provided. If a publication is nested in a group of related publications, the written or pictorial elements of the publication are continually updated when the written or pictorial elements of any member in the group of related publications are updated. For instance, when a group of nesting publications, such as a group of related ocean studies are created using the iterative system, those studies or publications are interlinked. The iterative system is capable of and could be used to continually update the entire group of nested publications. To further explain this, let's consider a group of interlinked news articles related to art museums across the world, that are published using the iterative system. When the relational element/compound relational element of one of the publications changes, those elements are updated across all the nested publications that rely on those elements. For example, let's consider a scenario where the news article on Metropolitan Museum relies on or cites any relational/compound relational element embedded within the news article on Tate Modern museum. When the relational/compound relational element embedded in the Tate Modern article changes, those data are also updated in the Metropolitan article, thus providing updated articles to the users.

In another embodiment, an iterative publication method for generating a continually updating publication is provided. In an exemplary embodiment, the method may comprise a step of selecting one or more project requirements provided on the publication creator (or publication creator interface) of the iterative system described hereinbefore. This may be followed by a step of incorporating a user dataset using the data input filter of the iterative system and selecting one or more external dataset(s) using the data selection filter of the iterative system. Once the datasets are incorporated, the publication method involves a step of identifying a relational element or a compound relational element embedded within the user dataset or the one or more external dataset using the iterative data identifier of the iterative system. Once the relational/compound relational elements are identified, a step of generating the written or pictorial elements of the publication based on the one more project requirement, the user dataset and the one or more external dataset using the publication generator of the iterative system follows. As explained hereinbefore, the iterative data identifier then continually updates the written or pictorial elements of the publication when any relational element or the compound relational element of the user dataset or the external dataset is updated.

The method may further include a step of validating, reviewing, suggesting changes or editing of the user dataset. As described hereinbefore, the step of validating, reviewing, suggesting changes or editing could be done by the publication editor of the iterative system.

In a further embodiment, the method further comprises a step of identifying a source of the relational element, the compound relational element, or the written or pictorial elements of the publication by the source identifier of the iterative system. The method involves a step of generating a sourcing information based on the source of the relational element, the compound relational element, or the written or pictorial elements of the publication. The method further involves a step of updating the sourcing information when the source of the relational element, the compound relational element, or the written or pictorial elements of the publication changes.

### Technical Discussion

Data-based projects have been historically and even presently are performed in a linear, static, and opaque way that is separate from the publication process, which can lead to delayed discoveries and decision making, errors, mistrust, and/or a plurality of other problems.

An example of the historical publication system may include health science researchers that study COVID-19, who, after obtaining funding and ethics approvals from institutions, may set out to compile and collect data using various methods such as clinical trials, surveys, laboratory experiments, or observational studies. They may then analyze the data using standard statistical techniques and software to draw conclusions and identify patterns or trends. They can then add their interpretations of the findings and prepare a document for publication. Once the document is formatted for the target journal, the authors may then submit it for publication consideration at the preferred journal. The journal may then send the document out for peer-review by two or more experts in the field, who may provide feedback and recommendations to the journal editor and authors to help to ensure the rigor and accuracy of the research. They may recommend publication, rejection, revision, or other direction. The editor may make the final decision regarding publication. If revisions are required, the document may go back and forth between the journal and authors, until the paper is accepted for publication. Once accepted, the journal may format and prepare the manuscript for publication, and then they may publish it online, in print, or both. The publication may then be given a persistent identifier, such as a Digital Object Identifier (DOI), where it then may go into post-publication review and scrutiny by other experts, decision makers, the public, and more. This publication system takes a long time to go from data acquisition and analysis to publication, and once published, prevents the study from being updated. In this instance, the lack of updated information can have significant health consequences for the public as these studies drive public health decisions.

Another example of the historical publication system may include ecologists who may go into the field, such as a forest, ocean, lake, mountain, wetland, and more, to gather data. Observations may get recorded with pencil on paper or directly into a spreadsheet; data may also be gathered from sensors, tags, and other hardware-software devices that may be delivered to spreadsheets. These data may then be combined into standardized spreadsheets, where author(s), scientist(s), statistician(s), collaborator(s), or other people may perform quality checks and assessments using entry level statistics, then they may perform advanced statistics and mapping before generating figures that may display the results visually. Next, the ecologist(s) may review and interpret the results generated by the analytical procedures and they may prepare a draft document that conveys the findings. Once the author(s) feel the manuscript is ready for publication, they may format it for a suitable journal following the journal's guidelines. The editor(s) at the journal may then send the manuscript out for peer-review by two or more experts in the field, who may provide feedback and recommendations to the journal editor and authors. They may recommend publication, rejection, revision, or another combination. The editor may make the final decision about the publication and, if not rejected, it may go back and forth with revisions. Once accepted, the journal may format and prepare the manuscript for publication, and then they may publish it online, in print, or both. The publication may be given a persistent identifier, such as a Digital Object Identifier (DOI), and then it may go through post-publication scrutiny by other experts, decision makers, the public, and more. Occasionally, if errors and omissions are discovered, a corrigendum, correction, clarification, or retraction may be made to the publication. Aside from these instances, the publication remains locked in its published form. This can significantly hamper the field of ecology, as well as those decision makers that might use this information to make policy decisions in response to changing environmental conditions. This static publication system is particularly problematic in this field where continuous observations (e.g. from sensors or field scientists) can readily update the current knowledge base.

Another example of the historical publication system may include fisheries assessments. Data that are used in fisheries assessments may come from fishers, fisheries observers, government scientists, landings monitors, remote sensing instruments, automatic identification systems (AIS), and more. These data may be entered with a pencil on paper, streamed from Application Programming Interfaces (APIs), video surveillance, remote sensing, and more. A statistician, fisheries scientist, or other person may extract and explore the fisheries data, perform quality assessments and controls, analysis and visualization, and they may write up reports for internal or external review and they may submit it for publication. Publications may be through fisheries journals, internal business or government reports, academic researchers, third party reviewers, fisheries associations, sustainable fishing labels, and more. Once reviewed, the report may be returned to the authors for revisions, and then for publication and dissemination. Decision makers may use these results and reports to make decisions, including setting seasonal fishing quotas and bycatch limits. Using the current, static publication system, these decisions may be made from outdated data, which could negatively impact fish populations and have far reaching ecological and economic implications.

Another example of the historical publication system may include environmental impact assessments where a team of field technicians and scientists may collect, gather, or process data about an area, ecosystem, species, watercourse, and more. These data may be collected with pencil on paper and then entered into a spreadsheet, directly into a spreadsheet on a tablet, or through sensors like drones and water quality sensors. Then, the scientists, technicians, consultants, or others may process and query the data, analyze and visualize the data, and they may write up a report for review. The report may go back and forth between the authors, clients, reviewers, and others until it is satisfactory, and the report is considered complete and it may be published.

Another example of the historical publication system may include war correspondents and journalists. Once in the field, the war correspondent may gather data, photographs, eye witness accounts, and other information in a variety of ways such as through on-the-ground observation, interviews with eyewitnesses, smartphones, cameras, audio recorders, and remote sensing like drones to document what is happening. As they collect data, they may begin to form a story that helps them to prioritize information that is timely, relevant, and of public interest, and they may create a document that conveys the situation in a balanced and accurate way. Once written, the report may go through review by the publisher's editorial team who may provide feedback and suggest revisions. They may go back and forth until it is ready for publication. Once published, the publication may remain static until, for example, a corrigendum, clarification, retraction, or other modification is required. This lack of updated information for the public to digest may negatively impact the safety of those in the war zone and may misdirect important military, health, and political decisions.

Another example of the historical publication system may include the tracking and reporting of carbon emissions and capture. Tracking and reporting on carbon capture may involve measuring and monitoring the amount of carbon dioxide (CO2) that is emitted and stored from various sources. This data process may rely on data collection, with standardized methodologies and protocols to calculate and track emissions and storage through space and time. These data are then processed, analyzed, displayed and visualized, and then a document may be prepared and submitted to a scientific journal for publication. Once received, the publisher may send it for expert review, then if revisions are required, it may go back and forth between the authors and the journal until the journal may accept it for publication. Then, it may go through pre-publication processing and formatting before being published online, in print, or both. Once published, the publication may be read and reviewed by the public, decision makers, and others. Again, the lengthy, static publication system currently in place would hamper adequate carbon emission tracking and decision making, thereby having negative downstream environmental, health and economic impacts.

In all of the above examples, the historical publications would benefit if they were created using the proposed continually updating publication system and method. Traditionally, the process of preparing a document may involve writing an abstract, background, introduction, materials and methods, eyewitness reports, results with figures and tables, discussion, conclusion, acknowledgements, author roles, conflicts-of-interest statements, references, appendices, and a plurality of other information. The document may be formatted and, when the administrator(s) decide the document is ready for submission, the document may be sent to a publisher or editors for review. If the handling editor of the publisher agrees to review the document, the document may then be reviewed by the editor and sent to a plurality of reviewers. Once the reviewers have had sufficient time to review the draft paper, their assessments of the document may be returned to the editor who then may distribute the comments back to the administrator(s). Assessments may include ‘reject’, ‘accept with major revisions’, ‘accept with minor revisions’, ‘accept’, and other variations. If the document is not accepted, it may go back and forth to the same publisher or different publisher until the document is abandoned or accepted. Each time the document is reviewed, it may be reviewed in its entirety.

Once the document is accepted by a publisher, the accepted document will move into a publication process, whereby the accepted document goes through formatting, assigned a persistent identifier, and published in digital and/or hardcopy form where the publication may remain static except in the case of corrections, clarification, corrigendum, retractions, and other circumstances. However, the proposed system/method allows creating a continually updating publication i.e. a publication that is current and up-to-date with the latest available data/information/trends. The content or the written or pictorial elements of the publication continually update when new data is published or fed into the system.

The term written or pictorial elements could be any human or AI generated text elements that could include an abstract, background, introduction, methods, results, discussion, conclusion, citations, journalistic notes, stories, acknowledgements, ethics and acknowledgements statements, funding statements, or any other portions of a publication. These written or pictorial elements may have relational elements or compound relational elements embedded, optionally, within its text, graphs, maps, tables, pictorial content or any other content, which are identified and tracked by the iterative system. When data pertaining to any of the relational/compound relational elements change or if new data becomes available, the iterative system updates the relational/compound relational elements i.e. replaces the old relational/compound relational elements with the new relational/compound relational elements, thereby providing an updated publication.

The term “relational elements” refers to elements that may be embedded into any written element. They may refer to other pieces of information contained within a project's display, other projects in the system, or to other external documents, without being limiting. Relational elements may include values, results, summary statistics, year ranges, study locations, methodologies, citations, figures, text, and more. For example, a project may report in its introduction or background that “40% of corals have disappeared from the Florida Keys between the years 1970 and 2029”, where ‘40%, ‘1970’, and ‘2029’ may be relational elements that relate to another active project in the system, such that, as long as the relational project was still active and updating in the system, the relational elements would be automatically updated to 2030 the following year and the percentage would also update to reflect the current status of corals in 2030. Relational elements could be used in any part of the publication and may be transparent so that a consumer may examine the source of the relational element(s) and trace it back to its original source.

The term “compound relational elements” refers to elements, such as calculations, statistics, or suites of values, that may be used to fill a relational element. For example, if a global project on coral reefs aimed to summarize the status of all coral reefs, the compound relational element may use an average status of coral reefs across 50 different projects from around the world, thus displaying the global trend. Another compound element may refer to a list of all the countries included in the summary statistic. The compound relational element would be transparent so that the consumer may examine how and where the value came from.

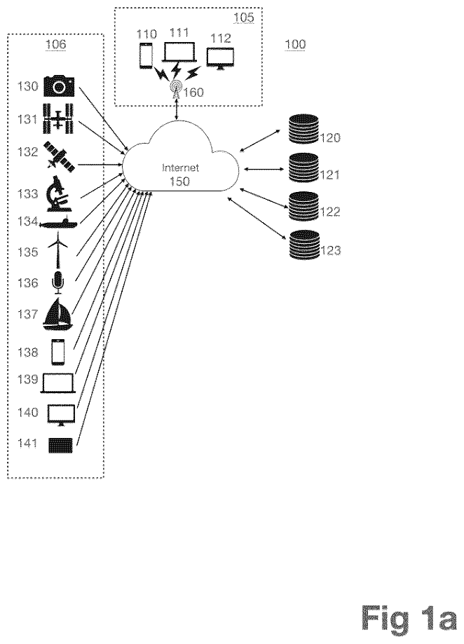

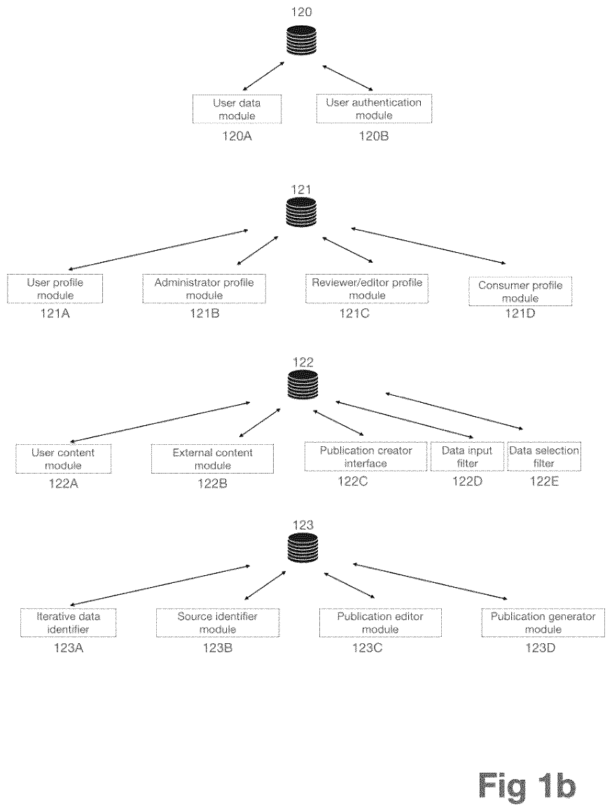

The relational and compound relational elements could be defined in a variety of ways. For instance, in the text of the written elements of the publication, e.g. Globally, coral reefs have declined by [XX %] {compound relational} , with the biggest declines occurring in [Country] {relational} by XX % {relational} and most intact in [Country] {relational} by XX % {relational} . Whereas, in graphs, maps, tables, or other pictorial elements of the publication, the publication system and method may gather relational and/or compound relational elements and combine from different tables and graphs to make the nested ones. E.g. Graphs, maps, and tables that describe the global coral reef condition, may be populated by direct raw data or by relational/compound relational elements, such that ‘FIG. 1. Scatterplot of global coral reefs with one line showing the global coral reef conditions [compound relational], and individual lines [relational elements] that show the data for each country. In some instances, to see the relations, there may be persistent identifiers such as QR codes, pixels, numbers, formulas etc.

For example, there are two million lakes in Canada. Hundreds are monitored by provinces, territories, non-profit organizations, community groups, and more. Currently, each lake and watercourse is monitored separately with each group producing their own datasets, analysis, reports, and actions. There are some regional nodes that store these data for others to view and use, but it's still all manual. If an organization wanted to document the health of all of Canada's freshwater ecosystems, for example, such as to find the best and worst conditions, someone would have to bring all the data together and analyze and report it separately.

With the new iterative publication method and system, each organization may have their own data-based projects with publication in the system, each with their own teams, data, results, written elements, and more. For example, a Lake Ontario project may document that the average pH of the lake is 8. Then, there may be a Canada-wide project (a nesting project) and publication that may be based with relational elements and compound relational elements, such that the Canada-wide project would describe the state of Canada's freshwater ecosystems by utilizing the results of all the independent projects. The relational elements may refer directly to the specific projects, wherein a section of the project may refer directly to the [Lake Ontario] (relational element) project and state that its pH is 8 (relational element), this would be displayed in the pictorial and written elements. The Canada-wide project may deploy a compound relational element that, for example, captures the pH of all the lake projects and presents the average pH across all Canada's lakes (compound relational element->average (pH: Canada's Lakes, referring to all of the available projects)) and the lake with the lowest pH (compound relational element: min (pH: Canada's Lakes, referring to all the lakes). In this case, an abstract for the Canada-wide project may read, for example: “Canada's freshwater ecosystems are important to Canadians. pH is an important indicator of lake health, dictating what can live in a lake, how healthy it is, and how it functions in terms of social value and biodiversity. This project is a synthesis of {3,000} (Compound relational: sum of number of projects) lakes and watercourses across Canada. The lake that is most acidic is Loon Lake (compound relational element: minimum pH across all lakes, display lake name) which has a pH of 6 (compound relational element: minimum pH, across all lakes, display value). In this way, as each of the independent projects updates their data and results, so too does the Canada-wide project.

In another example, relational and compound relational elements may be used for tracking viruses at local, regional, and global scales. To keep publications up to date, projects and publications that document the spread of a new virus may be done at the municipality scale, which then scale to the country, region, or world. For example, a country wide nesting project may refer to the results of each municipality and then scale to the presence of the virus across Europe. These results may be shown through written elements or pictorially. The abstract, for example, may state that “A virus is rapidly spreading across Europe. Since it was first detected in 2008, 15% (compound relational element: average infected) of people have been infected, and France (compound relational element: maximum, country name) has the top infection hotspot with an infection rate of 28% (compound relational element; maximum value). The virus started in Germany, however, and it has since declined, now only impacting 7% (relational element) of the population.

In another example, country-wide and global deforestation may be documented. Relational and compound relational elements may be used to keep publications up to date at the local, national, and international scales that document forestation and deforestation rates. For example, trees standing, planted, and cut down in a country may be documented and published, at the local, county, and country scale. A global nesting project may be created to map and track global forests and it may, for example, state that “Forests grew by 20% (compound relational element, total gained—total lost) in 2025 compared to the base year of 2020 (compound relational element: minimum year). Forests in Brazil, Canada, and Russia, the three largest nationally managed forests, increased by 15%, 3% and 7% (relational elements).

Modifications may be made to various parts of a project, and all modifications are recorded and noted, with previous versions being made available to view. For example, a new data source may be added or removed, a statistical analysis or display may be added or removed, and data points may be added or removed, and all changes are documented and visible to consumers or users. For example, a consumer may see a new trend showing up in the data results and visualizations that do not coincide with the expected or current findings. They may then flag this for review. Depending on the nature of the flag, the review may go to the project's administrator, other consumers or users, or AI. For example, a review may show that one of their sensors or instruments needs to be recalibrated. They may then take the sensor offline and remove the data that were collected when it was not calibrated. All the removed data are stored separately from the used data and are transparent, and notes may be attached describing why those specific data points were removed from the system. The term “flag” may refer to a notification regarding a certain part of a publication that needs correcting or reviewing. Flags may include incorrect spelling, an incorrect relational element, compound relational element, an outlier in the data that needs to be investigated or commented on, a deviation in the data, a new interpretation that is needed, new citations that may be added, recommendations of new or outdated data sources, and/or new or outdated written or pictorial elements, without being limiting. Flags may be transparent.

The term “iterative” means that active projects are updated automatically when new data, written or pictorial elements, relational elements, compound relational elements, sponsors, funders, without being limiting, are updated. For example, a project that describes sea surface temperature may ingest data from an array of sensors through the data input and filter and it updates as the data comes in. The administrator and/or AI view the results and amend the written or pictorial elements as needed. At the same time, any relational elements, compound relational elements, and citations are updated so that the most up-to-date information and data are presented. For example, if the data are being fed in the iterative system by a sensor, a publication may cite or use the numbers obtained from the sensor data, and as and when new data are obtained from the sensors, the publication updates to cite the newly available sensor data.

The term “activate” or “activating” with regards to a project means that the project becomes public-facing and iterative, adding new data and written or pictorial elements to the project as they are added and displaying them for users to see. Projects may be created and compiled but delayed in activation until the administrator wants the publication to be public-facing.

The term “transparent” from the above examples refers to the ability of publication viewers to view the background sources, raw data, and/or notes, without being limiting, for a variety of elements. For example, deleted and modified data may be recorded and visible with notes on the treatment decisions; clicking on photographs or data points within the displays may show the source and metadata, such as geolocation and time-stamped information; clicking on relational elements may direct the consumer to their original source; clicking on a compound relational element may display the methods used and the original sources; clicking on displays of data, such as tables, maps, and figures, may connect to the methods that created the display and those may connect to the original data sources; all changes may be noted and version histories may be available; prompts for reviews may be displayed; all changes may be noted; past versions may be available. The inventor also envisions that some elements may be non-transparent and may be hidden from public view for ethical or other reasons. For instance, patient personal information may be hidden from public view to ensure patient confidentiality. The inventor also envisions that ‘public-facing’ may be to anyone or to a select audience. For instance, clients of a proprietary project.

With respect to the term “quality checked” this may include checks for the correct data formatting, the optimal or minimum/maximum repetitions for the observations/experimental data, checks on the experimental methods used and the associated data generated, and checks on the source of the data, without being limiting. The quality checks may be done by the system, the human-in-the-loop, artificial intelligence (AI), and/or consumers or users, without being limiting. The human-in-the-loop could be an administrator, an evaluator, whose sole role is to evaluate the incoming data, a contributor, or any other person involved in the project.

The term “citations” refer to other sources of information. These may include personal reflections, personal communications, eyewitness accounts, references to other documents within and outside the system. Citations may be removed from a publication, for example, if it refers to a retracted document that was disproven or discredited. This change may be transparent.

With respect to the previously defined analyses and displays, this is envisioned to include any mode of data analysis or display that would be available to the individual to portray data in an adequate and informative way. Different analyses are suitable for different projects. The administrator or AI may select the statistical analyses that are suitable for the project. These analyses may range from simple to advanced analyses and may include simply showing the data points, such as a photograph, or a summary of data points such as the mean, median, mode, range, variance, standard deviation, correlation analysis, regression analysis, T-Test, Chi-Square Test, ANOVA (Analysis of Variance), frequency distribution, map, histogram, scatter plot, box plot, pie chart, bar graph, line graph, time series analysis, cross-sectional analysis, ratio analysis, proportion analysis, percent change analysis, Index Numbers, Benchmarking, Sensitivity Analysis, Likert analysis, cluster analysis, discriminant analysis, factor analysis, principal component analysis (PCA), mark-recapture analysis, survival analysis, time-series decomposition, ARIMA (AutoRegressive Integrated Moving Average) Modeling, Monte Carlo Simulation, Markov Chain Analysis, Bayesian Analysis, Content Analysis, Network Analysis, Multivariate Analysis, Multilevel Modeling, Structural Equation Modeling (SEM), Path Analysis, Latent Growth Curve Modeling, Longitudinal Data Analysis, Causal Inference Analysis, Machine Learning Algorithms (e.g., Random Forest, Support Vector Machines), Neural Network Analysis, Deep Learning Analysis, Natural Language Processing (NLP) Analysis, Sentiment Analysis, Topic Modeling, Image Analysis, Spatial Analysis, Geospatial Analysis, Remote Sensing Analysis, Time Series Forecasting with, Exogenous Variables (ARIMAX), Hierarchical Clustering Analysis, and Nonlinear Regression Analysis, without being limiting.

In an exemplary embodiment, there could be two different types of “users”, there are two: 1) users, or AI, that creates, runs, executes projects, and ii) users, or AI that consume the projects. As one would understand, an admin type user could also be a consumer for other projects, but not necessarily the other way around. For instance, admin type users may include, lead admin, founding admin, take over admin, data contributors, internal reviewers, students, or technicians. This may be one or more than one person, and may include AI, but these are people who create the project, pay for the project, determine project objectives and goals, contribute data or decide on data, selects external data sources, provide written or pictorial elements, and internal reviews. These could be technicians, scientists, citizen scientists, journalists, editors, managers, etc. Consumer side users could be anyone on admin side, as well as funders, stakeholders, managers, students, scientists, journalists, decision makers, policy makers, advocates, project clients, publication clients or any common reader or public user including AI.

The coupled iterative data-publication method and system may be used by a plurality of users, including but not limited to administrator(s), contributor(s), decision maker(s), inventor(s), consumer(s) or user(s), and a plurality of other roles wherein the administrators(s) may have a role in creating, managing, running, or otherwise contributing to the project; contributor may provide data and other related information to the project; and the consumers or users may consume the information contained within the publications. System users may include a plurality of other users, including administrator(s), contributor(s), and/or consumer(s) or user(s), but also funder(s), sponsor(s), collaborator(s). Funders are individuals, organizations, or entities that provide financial resources to support a particular initiative, project, or cause. These resources can come in the form of grants, donations, investments, or other financial contributions. Funders typically have a vested interest in the success of the project or initiative and may require accountability and reporting on how their funds are utilized. Sponsors are entities or individuals that provide financial support or resources for an event, program, project, or individual in exchange for recognition, visibility, or other benefits. Sponsors often contribute funds, goods, services, or expertise to support the initiative and may receive branding opportunities, advertising exposure, or other promotional benefits in return. Sponsors can include businesses, corporations, government agencies, or individuals, without being limiting, interested in aligning their brand or values with the initiative they support.

For example, a governing body that is responsible for the stewardship of a nation's ocean resources and their habitats may dictate what is and is not allowed in an area, such as vessel speeds in the presence of whales. When and what speed is allowed may be determined by many factors, including the time of year, types of whales, types of ships, etc. Gathering and processing the data that are necessary to understand all these dimensions to set the speed limits takes time and a lot of data and different types of expertise. In using the data-publication method and system, a government official may be an administrator and create the primary project. They may then assign other administrators, data contributors, funders, sponsors, and collaborators to the project, which may include fishers, whale watchers, researchers from other government departments, aquariums, universities, consultants, or other roles, who may also be simultaneously using the system in a similar way to study a plurality of other topics and/or fields, which can then provide up-to-date data to answer the complex, multifaceted questions that they are tasked with answering. In an embodiment of the present invention, a plurality of projects may also be combined into a single, or a plurality of other projects. For example, biologists studying humpback whales, orcas, dolphins, turtles, plastics, and pollution may combine each of their projects to study animals or ecosystems as a whole.

In some embodiments of the invention, related projects may be determined and/or recommended to the administrator(s). These determinations and recommendations may be done by other users of the platform, by consumers or users, or by AI, without being limiting. For instance, if a project exists that is investigating blue whale populations in the Pacific Ocean, AI may match other projects related to krill and humpback whale populations in the same region to a person associated with the blue whale project (e.g. administrator or contributor). That person can then contact the creator(s)/administrator(s) of the other project(s) and run a combined project with their shared data.

As described herein, an iterative and coupled data-publication method 200 and system 100 provides for a research project to be executed in tandem, or near-tandem with a publication. For example, where a biologist may gather data from a plurality of devices that send data over the Internet, and where those data automatically are sent to the supported project(s), quality checked, and sent through previously defined analyses and displays following one or more instructions provided during project creation. Once the administrator(s) accept the received results, which may also be verified by the system or other administrator(s), the publication may be updated for viewing by the consumer(s) or user(s). In some aspects, the consumer(s) or user(s) may subscribe to, or ‘follow’, one or more publications and may receive a notification when the publication is updated. These notifications may come in the form of emails, push notifications, sound notifications, in-app notifications, badge notifications, banner notifications, scheduled notifications, text notifications, without being limiting.

In an embodiment of the invention, the analyses and displays could be selected during project creation and modified over time depending on the needs of the project or the usefulness of the incoming data, without being limiting. However, as projects build in the iterative and coupled data-publication system, artificial intelligence pro-grams or the system may be able to suggest, for example, statistical packages, experiments, and display items, given the data types, questions, objectives, and other parameters set in the project. The system or AI may also be able to look at other projects on the platform or other studies conducted outside the platform to determine or adjust the analyses and displays used in a given project. For instance, a coral reef monitoring project in Florida would likely need/want/use the same analytical packages as those used in a study in Australia, Fiji, etc. Thus, the system, AI, or human-in-the-loop may opt to use the analyses and displays used in those studies, which may or may not be in the platform of the current invention.

In an embodiment of the invention, verification of the data or results from experiments or observations may include checks on potential outliers in a dataset, checks on potential errors in the data that indicate a problem with the source, or other checks as would be known to be conducted in the art. These checks may be done by the system, a human-in-the-loop, or AI, without being limiting. For example, if a project is active in the platform and is collecting data on coral reef coverage in Australia, and coral reef coverage is known to be no more than 25%, outlier data points that show 70-100% coral reef coverage may trigger a warning to the administrator to examine the data point closer before accepting it. As the system gathers more data, it could use AI to refine and understand that it may be normal for that location and adjust the verification system in place accordingly.

In an exemplary embodiment, the iterative system and method may also provide a traceability feature. For instance, one can click or hover on any photograph, graph, map, relational or compound relational element that is embedded in a publication, which would take the user to the original source of the data. In some instances it may be anonymized or only metadata may be provided. For instance, the metadata could be a QR code, barcode, a pixel, or any other unique and persistent identifier.

FIG. 1 demonstrates a high-level hardware architecture of system 100 for executing the aspects as described herein. The administrator(s) uses devices 105 to login to the data-publication system 100 via the Internet 150 through an access point 160. Using a display on the device 105, the administrator(s) logs into the system 100 and may be authenticated and would be able to access at least one of the servers 120, 121, 122, 123.

An administrator(s) and/or consumer(s), user(s), interacts with the device 105, such as a smartphone/tablet 110, laptop 111, or computer 112, without being limiting, that is in communication with a wireless or other access point 160 such as 3G, 5G, LTE, WiFi, Bluetooth®, landline, or other communication channels. The communication access point 160 may allow the devices 105 to communicate with other devices over the Internet 150. In addition to the user devices 105, a plurality of data gathering devices 106, such as cameras 130, drones 131, satellites 132, microscopes and lab results 133, underwater vessels 134, atmospheric sensors 135, acoustic sensors 136, vehicles 137, smartphones 138, laptops 139, computers 140, and other sensors or data storage devices or warehouses 141, may also be connected to the Internet 150 (either directly or via a similar access point 160 as previously described) to deliver and share data, metadata, and other information. The system 100 comprises an authentication server 120, a profile server 121, a content server 122, and a data processing server 123. The authentication server may be a computer or a system that manages processes that allow access to a network, application, or system. The authentication server acts to ensure that the person accessing information is allowed to access this information. Authentication could involve one-step authentication through the use of a username and password, without being limiting, or it could involve two-step authentication, where a username and password is used in conjunction with a system-derived code that would be sent to the user via text or email, without being limiting. A profile server may be a computer or system that stores the profile settings created by a variety of users, e.g. profile settings associated with a consumer, an administration, an editor, a reviewer (which may be a computer, or an artificial intelligent system). A content server may be a computer or system that stores information that the platform uses or produces, this could include, user profiles, user uploaded content, external data sources, project information, standard experimental methods, standard data analysis and display options, publications, history of publications, history of reviews, reviewer comments, raw data, and/or summarized data, without being limiting. In an example, a whale biologist may use the authentication 120 and profile servers 121 to create and sign into their account, add historical data that may have been collected for decades via an API provided by the content server 122, may add existing data from one or more open source repositories, and/or may request new data to be added from mobile applications executing on the data gathering devices 106 (e.g. remote sensing, and acoustics). The data processing server 123 then processes the content as requested. In this way, their project can gather data from a plurality of external data sources.

The term “data sources” refers to the places where data are taken from, and may be single or varied, and may include user's own content, data warehouses or clearinghouses, or external data publications including handwritten notes, sensors and other hardware, eye witness accounts and interviews, hardware-software interfaces, human-hardware interfaces, mobile applications, without being limiting. These may be static, past data or real-time or near-real-time feeds of data that enter the system. They may be held in the system or external to the system until a project calls them in, let in by the filter for example, which then streams them into the projects that request them.

In an exemplary embodiment of the invention an iterative system 100 is provided. The iterative system 100 allows a user or an administrator or a project creator to generate a continually updating publication. The iterative system 100 comprises an authentication server 120, a profile server 121, a content server 122, and a data processing server 123, as shown in FIGS. 1A and 1B. The authentication server 120 may comprise a user data module 120A and a user authentication module 120B. The profile server 121 may comprise a user profile module 121A, an administrator profile module 121B, a reviewer/editor profile module 121C, and a consumer profile module 121D for publications with a curated viewer list. The content server 122 may comprise a user content module 122A, external content module 122B, a publication creator interface 122C (also referred to as a “publication creator, project creator”), a data input filter interface 122D (also referred to as a “data input filter”), and a data selection filter interface 122E (also referred to as a “data selection filter”). The data processing server 123 may comprise an iterative data identifier module 123A (also referred to as an “iterative data identifier”), a source identifier module 123B (also referred to as a “source identifier”), a publication editor module 123C (also referred to as a “publication editor”), and a publication generator module 123D (also referred to as a “publication generator”).

The user data module 120A may review and store any user entered data that could be used for authentication purposes, e.g. name, email address, password, date of birth, fingerprint, or any similar information. The user authentication module 120B may validate the user input during authentication with the data stored in the user data module 120A. If the user input matches with the information in the user data module 120A, then the user is successfully authenticated and allowed to access the iterative system/platform 100.

The user profile module 121A may store all the user's profile settings, which can be used to populate the user's profile upon successful authentication by the iterative system 100. The administrator profile module 121B would similarly store profile settings of the administrators, or lead administrators, or project creators, that initiate a new project or publication using the iterative system 100. The reviewer/editor profile module 121C would store profiles settings of users with special review or editing rights that are called upon to validate, review, edit, or suggest changes to the publications/projects, including adding or removing data or data sources, created on the iterative system 100. The consumer profile module 121D would store profile settings of consumers.

The user content module 122A stores all data or content shared or uploaded by the user on the iterative system/platform 100. The external content module 122B stores and provides access to a plurality of other and external information, such as datasets/data sources, such as third-party platforms, data shared by journals, data shared by government, data published on research databases, etc. The content server module 122 may additionally include a publication creator interface 122C that allows a user to select/specify the publication requirements, project guidelines or define additional parameters that would guide the creation of the publication, its validation, as well as review of the publication generated on the iterative system 100. The data input filter interface 122D allows users to select their own content from the user content module 122A i.e. content uploaded by the same user on the iterative system 100. The data selection filter interface 122E allows users to select from any external or internal data sources or datasets available on the iterative system 100 i.e. stored or accessible using the other or external content module 122B.

The iterative data identifier module 123A identifies the relational elements and the compound relational elements embedded in the user content or external datasets when they are pulled using the data input filter or the data selection filter interfaces (122D, 122E). The iterative data identifier module 123A keeps track of these relational and compound relational elements when they get embedded within a publication that is created using the iterative system 100. As and when the relational or compound relational elements change or get updated e.g. when new data becomes available, the iterative data identifier 123A will trigger an automatic update to these elements embedded within the publication, thereby providing a continually updating publication that is up-to-date.

The source identifier module 123B identifies the original source of any user content, any external data content, or any relational/compound relational elements embedded in the content. Whenever needed, the source identifier module 123B provides the original sourcing information of any content or written or pictorial elements of the publication. In an embodiment, the sourcing information can be triggered in a variety of ways, such as when anyone hovers over the user content, external data content, or any relational/compound relational elements embedded in the content. In an optional embodiment, smart glasses are provided that are synced with the iterative system and allow a user to see the relational/compound relational elements, sourcing information, and other metadata, when the user is reading any content published on the iterative system/platform.

The publication editor module 123C allows a publication editor, reviewer or critic on the iterative system or platform 100, or a user who is afforded editorial rights and called upon to validate, review, edit or suggest changes to content uploaded by a user to generate a publication. The publication editor module 123C may also be equipped with an algorithm or an artificial intelligent system that reviews the content uploaded by a user and then either validates, reviews, edits or suggests changes before it's used in the publication. The publication generator module 123D allows a user to generate the final publication based on the criteria or specifications defined by the user in the publication creator interface 122C. The publication generator module only accepts content that is either uploaded by the user or the external data sources, after it's processed by the iterative data identifier module 123A or the source identifier module 123B, and optionally processed by the publication editor module 123C.

For instance, when a marine scientist signs up on the iterative system/platform 100, she provides her details such as name, email address and other information that could be used for authentication purposes. This information is saved to the user data module 120A. When the marine scientist attempts to log on to the iterative system / platform again, the system 100 uses the data provided by the scientist when signing up from the user data module 120A to authenticate/validate a user before granting access. This authentication is performed by user authentication module 120B. Once authenticated, the scientist is granted access to her profile on the iterative system 100. The profile and other interface settings defined/selected by the scientist are stored in the user profile interface 121A, which are used to generate the marine scientist's profile when she is successfully authenticated. If the marine scientist is an administrator or has editorial rights, her profile settings would be stored either in the administrator profile module 121B or the reviewer/editor profile module 121C. When the marine scientist uploads her observations or content on the iterative system 100, her user content is saved in the user content module 122A. If the scientist decides to generate a publication based on her observations, she can use the publication creator interface 122C to create the project and publication. Using the data input filter interface 122D, the scientist can upload her own data/observations into the publication creator interface 122C and data input filter 122D by accessing the user content module 122A. Using the data selection filter interface 122E, the scientist can incorporate any third-party reports or observations in the publication creator interface 122C by accessing the external content module 122B. When the scientist's own content or any external content is incorporated in the publication creator interface, the iterative data identifier module 123A identifies any relational elements [e.g. direct to a single, existing value, such as year, location, a result, or any values] or any compound relational elements [e.g. using an algorithm that encapsulates a range of data and applies a logic function to inform the value displayed—for example an average across multiple projects, the minimum or maximum value in a list, the sum across multiple projects] embedded within the scientist's (user's) content or any external datasets. The source identifier module 123B identifies the source/sourcing information of the relational elements, compound relational elements, as well as any other written or pictorial elements of the publication. Once the user has formatted the content and is ready to publish, the publication generator module 123D publishes the publication. The written or pictorial elements of the publication can be reviewed by pre-defined algorithms, or artificial intelligence or by a human administrator using the publication editor module 123D. In some embodiments, content editing may be required based on the publication requirements, project guidelines or additional parameters defined by the scientist in the publication creator interface 122C. In some embodiments, the content would be auto-edited by an algorithm or an artificial intelligent system if the content does not meet the predefined parameters or scientifically known facts. E.g. if the scientist makes a typographical error by reciting the pH value as 17 instead of “7”, the algorithm or the artificial intelligent system may flag the error for review or auto-edit the typographical error. In some instances, content uploaded by the user/scientist may need further validation, review or editing, which can be done by the algorithm or the artificial intelligent system or by a human administrator. In a scenario, where the marine scientist obtains new sets of results/observations related to the same study, and she updates the original user content or her original observations stored in the iterative system, the iterative data identifier module 123A auto-updates/replaces the original observations [relational/compound compound relational elements] with the new observations logged in by the scientist, thus providing a continually updating publication. In an embodiment of the invention, every change or update in the written or pictorial elements of the publication is recorded and one can easily view the editorial history of the publication, to determine how the publication has changed over time, and specifically what parts of the publication have changed. This not only provides a continually updating publication but also allows a reader to see how the observations, interpretations, and other information have changed over time, thus providing latest recorded information to the reader.

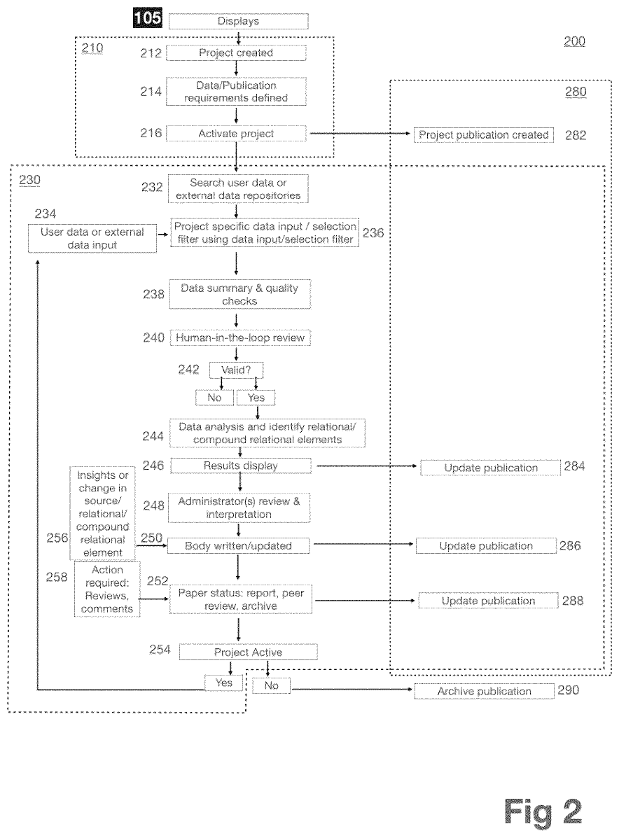

An overview of the method and process 200 for an embodiment of the present invention is shown in FIG. 2. In the exemplary embodiment, as shown in FIG. 2., the administrator(s) may launch the method 200 and system 100 via the device 105 to activate a project creator 210 [publication creator interface 122C] providing a user interface on the device 105 and an iterative publication generator 280 executing on the content server 122 and/or the data processing server 123. The administrator(s) fills out a template 212 provided on the user interface with project profile information 300 that enables the project creator 210 [or the publication creator interface 122C] to create 212, 300 and activate 216 the project with a data publication loop 230 [including 122B, 122D, 122E, 123A, 123B, 123C, 123D]. The administrator(s) may also define the project or publication criteria or requirements by defining the methods or data requirements 214. The term “project creator” refers to an interface where someone, which could be, for example, an administrator or AI, begins a project by filling out information that describes their project, such as the name of the project, data source(s), analysis and display types, funders, sponsors, background, and other written or pictorial elements that may include relational elements and compound relational elements. This sets the predetermined criteria, which is iterative and displayed to the public once the project is activated.

As indicated above, when an administrator starts a project they may be asked to fill out project profile information, which could include a photo of the person, affiliation, credentials, certifications, interests, roles, contact details, websites, IMPACT scores, ORCID IDs, links to Google Scholar, Research Gate, LinkedIn and other social media or professional websites, without being limiting.

During a project creation stage 210, 300, the administrator(s) may be provided with a list of previously defined methods 212, 360 stored on the profile server 121 to be displayed on the device 105. The administrator(s) may select from the list of previously defined methods 212, 360 that are standard and accepted in the field and then instructs the profile server 121 and the content server 122 to activate the project 216. The project may further be processed by the data processing server 123. Alternatively, in an embodiment of the invention, the administrator may define methods that are not previously defined and stored on a server and then subsequently activate the project. Following the activation 216, a publication 280, 282 is displayed by the content server 122, and the data processing server 123 for a user, such as an administrator(s) or consumer(s) or user(s) to view and/or interact with using their display 105.

In an embodiment of the invention, the publication would be generated after the creation and activation of a project. In those instances where the project relies on data that has not been collected at the time of project creation, the results or analysis section of the publication may be empty, but the other sections of the publication (e.g. introduction and methods) could be published. Once the requisite data are gathered, the corresponding sections of the publication would be updated with the necessary results, visualizations, and other content, such as summary statistics, relational elements and compound relational elements. Alternatively, it is envisioned that the publication of any of the sections may not initiate until a certain threshold of data is reached, which then triggers the publication to be displayed for the consumer(s) or user(s). Depending on the project, there may be different thresholds for the amount of data needed before results could be displayed. For example, advanced, multivariate analysis will require more data than a scatterplot. Thus, the present invention will allow the administrator, system, algorithm or AI to delay or pause publication until there is sufficient data and results to display.

In some instances, the administrator may delay the public-facing publication until they have some/most/all the data added and/or provided some/most/all interpretations. Also, the administrator may temporarily hide a publication that was previously viewable by users if there are suspected errors that could lead to the spread of misinformation. These actions may be transparent for the users, with written communication as to the reason for the removal of the publication from view.

As indicated above, the users of the platform, such as administrators or consumers or users, may be able to interact with the publication displayed to them. Anyone using the platform that has access to a publication may query data, explore outliers, understand the relational elements and compound relational elements, they may explore citations, funders, sponsors, they may flag certain aspects for clarification, review, and/or trigger third party reviews, without being limiting. Some interactions with the publication maybe afforded to administrators or those given per-mission by administrators. For instance, administrators may do all of the above as well as edit data sources, clean and comment on data sources or data points, edit the analyses and visualizations, edit the written or pictorial elements, sponsors, funders, acknowledgements, ethics, and other aspects of the project.

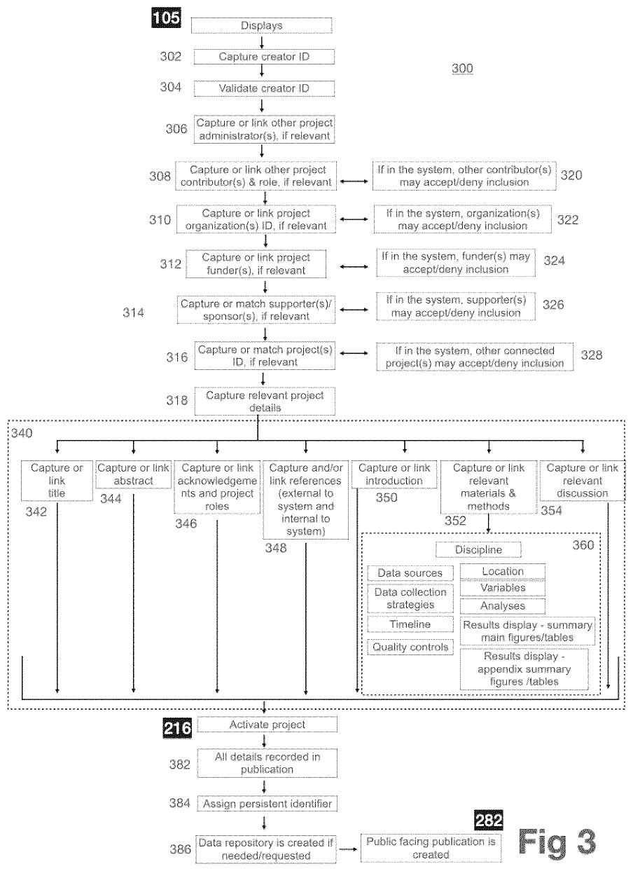

An overview of the project creator 210 [publication creator interface 122C] is provided in more detail with reference to FIG. 3. The administrator(s) uses a device(s) 105 to login to the system 100 over the Internet 150 through an access point 160 and then creates a project by capturing or linking a plurality of information 300. The captured or linked data could be data that already exists or data that is currently being captured in real-time, near real-time, or continuous over time. Alternatively, if the data needed for the project does not exist or has not yet been captured, the project may not display any data or analyses until that data becomes available and are validated. When the project is activated 216, a publication is created 282 for viewing by consumers or users on their displays 105. To create a project, the project administrator(s) may request the authentication server 120 to create an ID or login via the authentication server 120. If an administrator of a project has other existing (or previously existing) projects in the platform, they may be able to use their existing profile 302 to create a subsequent project, thereby linking all of the administrator's projects under one profile for ease of access. The system 100 may host and support a plurality of projects and/or project administrator(s), which may be linked to/from others throughout the system 306, 308-316 and 320-328. It may also be possible that all projects or publications created by a single administrator could be viewed by other users on one single interface to easily access projects related to their topic of interest.

In an embodiment of the invention, administrators may be given unique IDs when they create a profile on the system that can be used to capture or link the project to another party, such as other users or administrators 306, contributor(s) 308, organization(s) 310, funder(s) 312, supporter(s) or sponsor(s) 314, other project(s) 316, or other relevant information. For each link to another party, the other party may be shown this link and provided an option to accept, deny, investigate, and/or other action options 320-328. A template for the project specific details 300 may also be provided, where administrator(s) may select a plurality of information about the project, that may also be provided to the other party, including but not limited to title 342, abstract 344, acknowledgements and/or project roles 346, capture or link references and citations 348, introduction 350, discussion 354, and/or methods and materials 352. The methods and materials 352 may include a plurality of information, that are standard in the field or discipline, including but not limited to a discipline, data sources, data collection strategies, a timeline of interest, quality controls, a location, variables, analysis types, and/or results display, such as the display of text, tables, and figures in the main text and the appendices 360 through the administrator(s) and contributor(s) display 105. Once the administrator(s) activate their project 216 all the details of project creation 302-360 are recorded, and assigned a persistent identifier 384, such as a Digital Object Identifier (DOI®), quick response code, barcode, or other services. The project's data repository may be created 386 and may also have a persistent identifier provided. The results of the project creation 300 may then be displayed in the publication 282 via the display 105 for use by anyone who has access to the publication on the platform, such as administrator(s) and consumer(s) or user(s). As an example, a whale biologist may login and create a project. The whale biologist may link to or capture their co-authors, contributors, funders, other related projects, and a plurality of other information. Then they may add the project details that may include the study area (e.g., California), the methods of data collection (e.g., aerial surveys, acoustic sensors), variables of interest (e.g., location, date, time, species), timeline (e.g., 1970-present), data sources (e.g., specific historical or contemporary data sources, data collection methods), their analysis and results display needs (e.g., ANOVA with maps), and a plurality of other information. They may also write what is already known about the topic, to fill in the publication as it is known to the administrator(s) at that time, including but not limited to the abstract, introduction, materials and methods, results, discussion, conclusion, acknowledgements, references, and other relevant information. In other aspects, an artificial intelligence (AI) chatbot, such as ChatGPT or the like, executing on the content server 122 and/or data processing server 123 may be used to provide a historical summary of the topic for review and/or editing by the administrator. The content server 122 may record which portion of the historical summary is provided by the AI chatbot (e.g. AI portion) and which portions are provided by the administrator (e.g. administrator portion).

The content server 122 and/or the data processing server 123 may then search for inputs, either from user's own data or external data repositories and/or digest data 232 from a plurality of sources including but not limited to those that may be found on the Internet 150, fed in by the administrator(s) device 105, and/or live data streamed 234 from the plurality of data gathering or storing devices 106 via the Internet 150. For instance, if an orca sightings research project is created and the administrator selects some known data sources to pull data from, the system can also begin searching other unidentified data sources for relevant data.

The method 200 and system 100 may import relevant data to the project through a data input and selection filter function 236, 122, 122D, 122E where the system and administrator(s) performs data quality checks and assessments and summaries 238 according to the project's requirements as defined during project creation 122C, 210, 300.

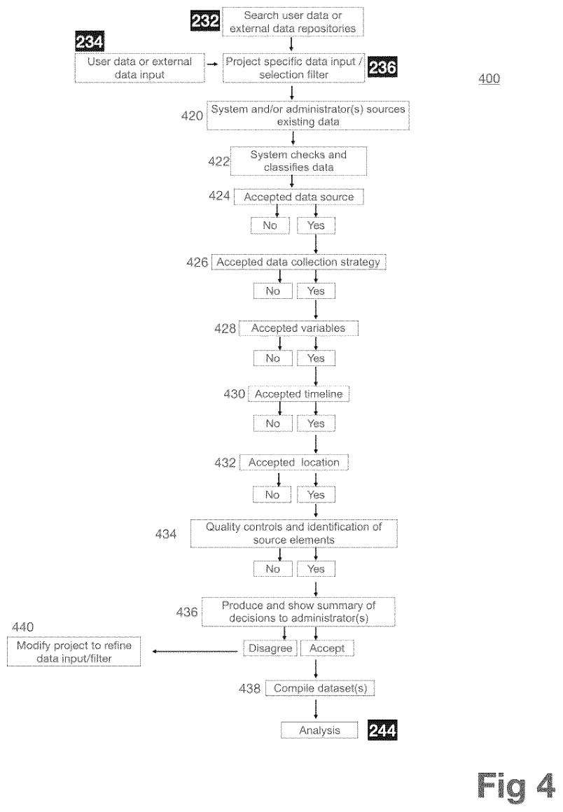

An overview of the data input and selection filter 236, 122, 122D, 122E executing on the content server 122 and/or data processing server 123 for the present embodiment is shown in FIG. 4. The content server 122 and/or data processing server 123 may use the information provided in the project creator 210 [publication creator interface 122C], 300 to user/external data source 232, 234, digest, and filter data 236, 122, 122D, 122E according to the project requirements before sending filtered data to the administrator device 105 for human-in-the-loop 240 validation 242 and then analysis that includes analysis of data and identification of relational or compound relational elements 244. Once the relevant data enters the input and filter module 233, 122, 122D, 122E, the system performs a plurality of data checks 422, including but not limited to the data source 424, data collection strategy 426, accepted variables 428, accepted timeline 430 (e.g., 1982-2032), accepted location 432, and/or quality controls 434. The identification of relational/compound relational elements/sourcing information by the data processing server 123 also occurs at quality control 434. For each check, validated data may move to the next check. After the filtering, the content server 122 and/or data processing server 123 may generate a summary and detailed view of the data selection and validation at each step for review by the administrator(s) 436. If the administrator(s) disagrees with any of the outcomes, they can make a plurality of decisions to, for example, revisit the project creator 210 [publication creator interface 122C] or the data sources, or data, to understand and correct the data flow decision and then rerun the input and filter until the administrator(s) receive a satisfactory outcome. Once the data are accepted, a project specific dataset(s) may be compiled for ease, traceability, and other benefits. These dataset(s) may then be fed into the analyses 244, 500. As an example, the whale biologist may provide a plurality of data sources and the system would then connect to or digest data from these sources then the systems would filter data according to the instructions defined in the project creator 210 [publication creator interface 122C], 300, so that the project may only receive the desired data. For example, data on the presence and absence of humpback whales from the years 1954 to 2025, in May-August, in California, from whale watchers and scientists using 1,000 m belt transects. After reviewing the data selection/rejection results, the administrator(s) (e.g., whale biologist) decides to limit to only those belt transects running at 5 km/hour, and modifies the project creator 210 [publication creator interface 122C] accordingly.

The accepted and validated datasets 242, 438 may then be passed to the data analysis to identify the sourcing information, relational or compound relational elements 244, 500 and results display 246, 500, where the analyses may be customized to the project at the time of the project creation 210, 300 or any time thereafter. Data may be processed and passed through the data analysis 244, 500 and then through the results display 246, 500, which may be shown to administrator(s) through their display 105. These changes update the publication 284.

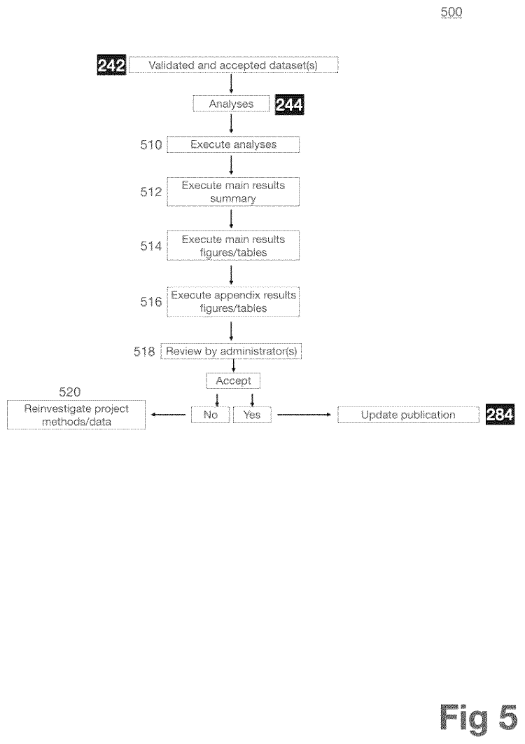

An overview of the data analysis and identification of relational or compound relational elements 244 and display executor 246 for the present embodiment is shown in FIG. 5. The content server 122 and/or data processing server 123 may use the Internet 150 to deliver validated and accepted data and dataset(s) to the project, which then executes a plurality of data processing and analysis steps 244 to display the results 246 to the administrator(s) on their displays 105 and/or to update the publication 284. Following the instructions provided by the administrators during the project creation 210, 300, the data/dataset(s) flow through the analyses 510, where the relational or compound relational elements and sourcing information is determined, and generate main results 512 including text, figures, and tables 514, as well as supplemental text, figures, and tables, which may appear in appendices 516 associated and displayed with the publication. The main results 512 may be shown to and reviewed by the administrator(s) 518 who may choose to reinvestigate the project or accept the main results 512 and displays, which may then update the publication 284. As an example, after the whale biologist has set up their project and confirmed the data sources and validated the data, then the existing and any new data from confirmed data sources that meet the projects requirements get analyzed and displayed to the administrator(s) and, the results that are accepted, may then be displayed for review and acceptance by the administrator(s), which updates the publication 286.

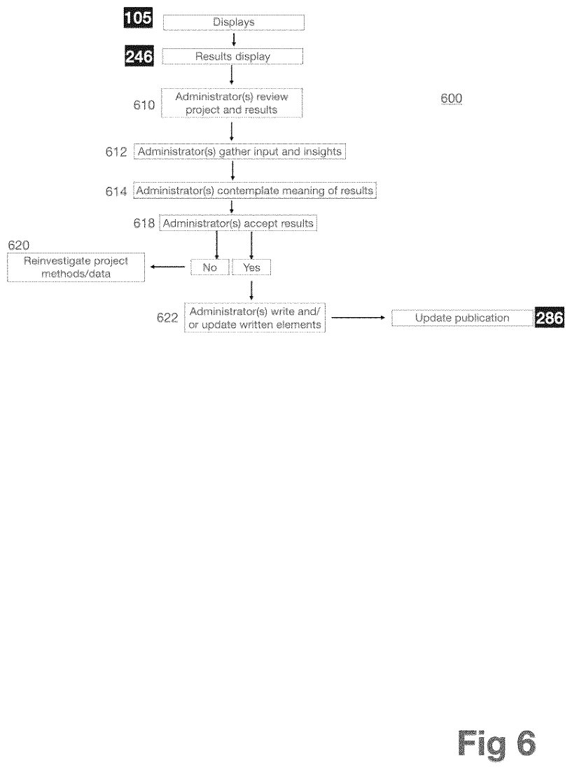

An overview of a process for which the written or pictorial elements of the publication is generated 280 for the present embodiment is shown in FIG. 6. Results 246, 500 may be reviewed by the system and shown to the administrator(s) through the display 105 where the results 246, 500 may be reviewed and interpreted 248, 600. After the system and administrator(s) reviews results 610 in the display 105, the system may generate new interpretations (human- or AI-derived) and modify references for context and the administrator(s) may gather input and insights from their own knowledge and/or a plurality of other sources 612 that may include, but are not limited to, peer-reviewed publications, gray literature, local insights, and other information. Upon re-flection of the results and the knowledge they have and have gained, they may then contemplate the meaning of the results and record, share, and collaborate with the other collaborators in the system to communicate their interpretations 614. During or after contemplation of the results, administrator(s) may then update the written or pictorial elements 622 of the publication, which may include results, discussion, abstract, conclusions, references, and other parts of the publication, including relational and compound relational elements, and may then be updated and shown in the publication 286. As indicated earlier, the administrator may be an algorithm, an artificial intelligent system, or a human administrator. As an example, a whale biologist reviews the results of their project that are produced by the method and system and, based on their prior knowledge combined with reading literature, gathering insights from local in-sight, and/or a plurality of other sources for insights and information, they may provide their interpretations and insights of the results of the whale population results into the publication. Once the administrator(s) of the project are satisfied with what has been added, the content server 122 and/or data processing server 123 pushes the changes to the publication 286. When a publication is changed it will be time stamped and the previous versions of the publication will be archived and time stamped. Users will be able to access any previous versions and also reference previous versions.

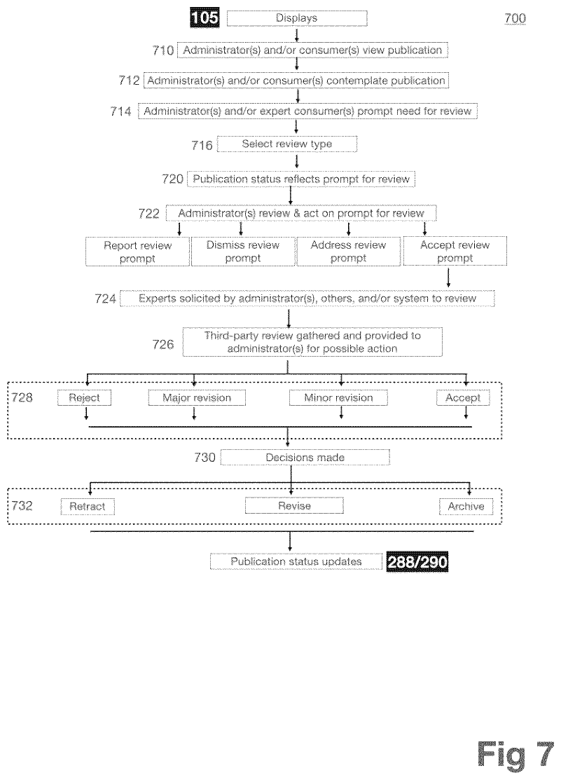

At any time after the project is activated, and as long as the project remains active, a prompt or series of prompts 258 may initiate an external review process 252. An overview of the iterative publication review generator 252, 258 for the present embodiment is shown in FIG. 7. When the publication is updated 280, different actions may happen that alter the status of the publication 252, 700. The system, administrator(s), consumer(s) or user(s), or a combination thereof, use devices 105 to view 710 and contemplate 712 the publication 280, including the results and written or pictorial elements. At any point in time, a review may be prompted on the publication of a project 280. The requested review may be prompted by the system, administrator(s), consumer(s) or user(s), or a combination thereof. A plurality of types of third-party reviews may be prompted 714, 716, such as a standard expert review, peer-to-peer review, administrator review, and may also include local knowledge review or other types of reviews. The review may cover the whole project or publication or part of the project or publication. After prompting a need for review of the publication, a publication status may be updated in the display 720 for administrator(s) to review and act on the prompt 722, where the administrator(s) may take a plurality of actions including, but not limited to reporting the prompt (e.g., harassment), dismissing the need for review (e.g., through clarification), addressing the review (e.g., fixing misinterpretations), and/or accepting the need for review. The administrator(s) them-selves may also prompt the need for review of their own project and publication. Once a publication is found to require external review, experts may then be solicited 724 by the profile server 121 or other methods to their device 105 to provide their assessment and review of the project and publication 726, which may be done in a one-way blind, transparent, or other review techniques known to the art. Reviewers may have access to the entirety of the publication and data or a subset thereof, and their comments may be made public or released solely to the administrator and those assigned to handle the results of the review.

Following review, the reviewer(s), system, or a combination thereof, may make recommendations for the way forward for the project and publication, such as to reject, retract, revise, or accept the publication 728. An authentication score (or credibility score) may be used on the public-facing publications to signify a credibility or authenticity of the publication, for example, where recently reviewed and accepted papers by multiple reviewers may have a credibility score that is higher when compared to ones that have not been reviewed. The administrator(s) and/or the system, or a combination thereof, may then make a decision regarding the presence of the project and publication in the system 730, which may include retracting, revising, or archiving the project and/or publication 732; following which the publication status may be updated and reflected in the administrator(s) and consumer(s) or user(s) display 280, 288, 290. For example, a whale biologist's project has been running for 3 years. It has 20 years of historical data and is continuously digesting new data from a plurality of sensors, which may be continuously feeding the project's data analysis and results display. The whale biologist keeps reviewing the results and updating the written or pictorial elements according to their own world view. One month, the distribution of the tracked whales changes significantly and the scientist (administrator) attributes the change in distribution to a change in prey distribution and writes these new findings into the written or pictorial elements of the publication. After the publication update, a consumer views this result and interprets the results differently, knowing that there has been seis-mic activity in the area that may have instigated the change. This consumer prompts a review of the publication, which updates the status of the paper, and the scientist (administrator) returns to the project creator, sources acoustic data from the area, and adds it to the analyses. After which, the scientist confirms the consumer's perspective, and finds that the noise is the most likely driver of change. The scientist updates the publication and resolves the review, which updates the status of the paper, and all changes are recorded with date and time stamps and are viewable in the system. This example highlights a particular advantage to the present invention, where up-to-date data is continually being provided to the consumer in an iterative way and only when there is an issue with what is being reported would there be a stop to the flow of information and a review. In an embodiment of the invention, during the review, the publication would stop acquiring, analyzing, displaying and interpreting new data until after the review is complete. In another embodiment, a version of the publication under review may be frozen in its current state, while another version is continually updated with data and interpretations, with an indication that the publication is under review.

According to some aspects, the content server 122 and/or data processing server 123 may be able to retrieve the project according to a date at the request of the administrator and/or the consumer. An historical view of the publication may be displayed as a comparison to a current view of the publication. In other aspects, the historical view may be displayed without a comparison to the current view.

As long as the project is active 254, the content server 122 and/or data processing server 123 may continue to attempt to digest relevant data 232, 234 for analysis 244, insights or change in source/sourcing information, relational/compound relational elements 244, 256, discussions, 250, actions 258, status 252, and other modifications that become available. The data publication loop 230 [including 122D, 122E, 123A, 123B, 123C, 123D] with publications 280 may continue to be updated for as long as changes are made and the project is active.

Once the project is inactive, such as when the project is complete, funding has stopped, or the scientists or journalists are no longer are pursuing the research question/hypothesis/story, then the publication may become archived 290 where the project may remain static but visible for ongoing use such as citations, readings, decisions, building future research projects, without being limiting. A project may be either reactivated at a later date by the administrator(s), or approved by the administrator(s), and may also be duplicated to be reinvestigated by another team(s). A reactivated project may import all of the parameters that were applied to the original project in order to replicate the original project using new data. In some aspects, new parameters may be applied to the original project to provide an updated interpretation of the original project.

In an embodiment of the invention, suites of projects may be created and executed in a replicating and/or nesting fashion. For example, a plurality of projects may cover the same area, such as a country, lake, or ocean. Replicating projects may be created at the same time or area. For example, a plurality of projects could cover one lake, where each project covered a unique species, for example, unique projects that cover birds, sharks, and whales within the same harbor. Replicating projects may also cover different areas of the same species, such as three states for humpback whales. Replicating projects may also cover unique organizations or communities, such as different researchers collaborating on sharks in the Pacific Ocean. There may also be nesting projects, where, for example, a large umbrella project contains a nest of other projects, such as a global coral reef project, with nested projects tracking corals at the country scale, and state scale around the world.

The term “archived” refers to projects or elements within a project that are no longer in operation. Projects may become archived for many reasons, such as the administrator has decided the project is complete, the data sources are no longer updating or available, the project funding is ended, or many other reasons, without being limiting. These projects may then be found in archives and then they are static, and can be accessed in a similar manner as current articles outside of this platform.

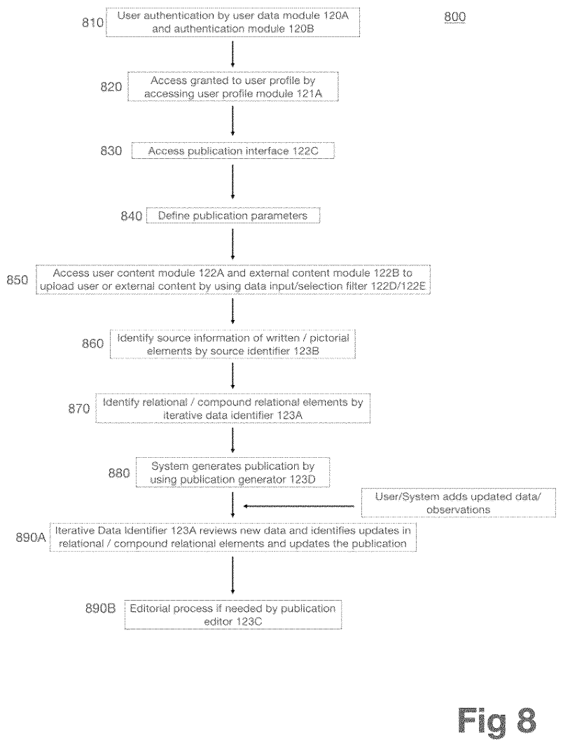

The iterative system and method are further explained by means of a flow chart in FIG. 8. A user, which could be an administrator, is authenticated at step 810 by the iterative system 100 and if successfully authenticated, granted access to their profile at step 820. The user then accesses the publication creator interface 122C at step 830 to generate an iterative publication. At step 840, the user defines the publication parameters and other publication requirements that would guide the publication. At step 850, using the data input and selection filter 236, 122D, 122E, user uploads her own con-tent/observations and selects third party content or datasets to be included in the publication. At step 860, the sourcing information of the written or pictorial elements are identified by the iterative system 100 through the source identifier 123B. At step 870, the relational and compound relational elements of the publication are identified by the iterative data identifier 123A. Once this is completed, at step 880 the publication generator module 123D generates the elements of the publication. At step 890A, the user uploads new observations, and data related to the same publication. This triggers the editorial process, and at step 890B, the publication editor module 123C, with the assistance of the iterative data identifier 123A, updates the relational/compound relational elements using the new data, thereby updating the written or pictorial elements of the publication.

A few non-limiting examples of iterative publications are provided below.

Coral Reefs: For example, an author in 2024 may write a news, magazine, blog, or scientific journal article about the global state of coral reefs. They may cite a paper from 2017 that declares that 20% of coral reefs have been lost globally. The data within that published paper may be from 2015 or earlier because the data analysis and publication process is long with many steps before publication, which means it is nine years out of date at the time of citation. However, it may still be the most comprehensive and recent paper published on the topic. In the fall of 2023, however, marine heat waves drove many coral reefs to near extinction making the 2017 values significantly outdated and inaccurate. Another issue is that publishers are typically only interested in publishing ‘newsworthy’ research with novel findings. So, the follow up papers to the 2017 paper are unlikely to be published and instead, they would get buried in a technical report that are typically hard to find or use.

On the other hand, the methods used to document trends in coral reefs, data collection and analysis techniques are largely unchanged since the 2017 publication, however if there are new data or results available, the graphs, tables, results, and some written or pictorial elements, such as the interpretations, could just be updated then the paper should still be relevant and accurate today. This is possible with the proposed iterative publication system and method, as the system tags/identifies the graphs, tables, results, and other written or pictorial elements as relational elements or compound relational elements, which allows continually updating the coral reef publication as and when new graphs or results become available.

With the current invention, the publication would be updated as new data and insights are fed into the system. If the global study used the new system, it could gather coral reef loss data from multiple countries simultaneously, not only keeping the global publication up to date, but also the country-specific publications [as explained in the nesting publications example above]. In this case, the multiple relational/compound relational elements across the global publications will work in tandem and update simultaneously as and when new data become available. This allows a consumer to see the global status of coral reefs, and then use the traceability feature or sourcing information to drill in to see the status by country to see which ones are doing the best/worst and this may be used to trigger many different actions, including policies, conservation funding, threat mitigation, and more.

Virus tracking: For example, the World Health Organization (WHO) may have a global project coupled with publication that tracks new viruses. This project comprises 180 country-specific projects, gathering and processing data and presenting results [relational/compound relational element(s)] on a global scale. In 2024, a new virus begins impacting middle-aged women in Sweden. Each week, as new data from tests are uploaded, the statistics on the demographics of people impacted and not-impacted updates in an iterative fashion for Sweden [individual iterative publication]. These statistics also pipe into the WHOs global project [nested iterative publications]. Many other countries nearby, and around the world, spin off their own projects to track this virus. All the tests that come back negative, show these results in the iterative publication. When the virus is detected in Finland, the project and publication for Finland updates to show the results, such as the percent of people infected vs tested, and this updates the results on the WHO project. This may show, for example, two hotspots on a global map, and updating relational and compound relational elements that describe, for example, the total number of people impacted, the age ratio, and other aspects. As the virus spreads around the world, it can be then tracked in near real-time. Then, as new interventions are introduced to slow the spread of the virus, such as social distancing and masks, then the results of these interventions may also be tracked and disseminated in an iterative fashion. For example, five counties may introduce mandatory masks, five other counties may introduce social distancing, and five other counties may introduce both interventions. These may be additional projects, or contained within a country-specific project. As the tests continue to generate data, the results continue to update, so that decision makers and the public have timely, transparent results to make informed decisions with. Making the science of this iterative and coupled with the publication. There may be some anonymity added to protect patient and sampler identities.

War documentation: For example, the BBC news outlet may decide to track an evolving conflict in Iceland. They may send a few of their reporters to Iceland to cover the conflict and gather data and stories. They may create a project-publication on the iterative system/platform to cover the story which includes the information they have to-date. Their trusted reporters may be the only data source for the project. The project may be set up to only include data with geolocated information from within Iceland's boundaries and time-stamped after Apr. 15, 2024. That may be the only data filter and sources they have set up. They may be documenting, through photographs and or other types of data such as forms and written or pictorial elements, and updating the written or pictorial elements of their story as they gather more data. The results [relational/compound relational elements] may include photographs, maps, graphs, and more that define the area extent, size, and impact of the conflict. Instead of writing and publishing a new article each day, this publication is just updated. And, because the data are streaming from a trusted source with location and time stamped information, the chance for misinformation, such as the use of outdated or out of location images to support or deny the situation, are eliminated. In this case, no anonymity may be added, so that the individual reporter who gathered the photographs and data may be known through the sourcing/traceability features. Moreover, the result is that readers who are following the story would get a continually updated publication.

Drought tracking: For example, farmer's and scientist's observations, remote sensing, field sensors, rainfall and flow sensors, and water extraction sensors that each measure and describe several relational/compound relational elements such as moisture content, evapotranspiration, carbon dioxide, methane, water level, and water clarity across a region may all be hooked up to the platform and system and filtering data for all of California. The system and publication would then describe the trends and current levels, using all these data. Then, any news outlet that wants to describe these trends can use sourcing/traceability elements, or use the system itself to generate new stories that document the trends and impacts—such as drought and flood—using up-to-date, traceable information. Then, another project may be activated to describe freshwater issues at the scale of the US, using compound relational elements for each state, and another could be done for all of North America, and the world, again using compound relational elements that gather data from all the unique countries, that are each gathering from the states, and thus providing a continually updating publication.

Fisheries tracking: For example, wild caught fisheries are still largely undocumented and unregulated. Most fish that are caught and kept or returned to the ocean, dead or alive, are never recorded. Simply, this is because there isn't a precedent of doing so. Those that are monitored are recorded on paper log sheets—from Canada, they are sent to India to be digitized. The digitized data are then sent back to the country that manages the fishery where they sit in a data repository until a scientist analyzes the data, and then produces a report and sets quotas for the fishery. In the new system, every fish can be recorded. This may be through on-gear or on-board AI, camera systems that turn video data into records of fish catch, with size, it may also be digital observations made by fishers or fisheries observers filled out through an app-based form, voice, or written. A project may be created in the system that gathers these data from the different data sources in one river in the Pacific Northwest. This project and publication may also link in all the water quality and quantity sensors, describing temperature, salinity, pH, dissolved oxygen, phosphorus in the river. It may also funnel in acoustic data that describes noise levels and the presence of predators or endangered species nearby. Combined, all these data come together to describe the state of fish in the river and the obstacles they face. Then, other projects may be set up exactly the same, covering each river in the Pacific Northeast. Finally, another may cover all the rivers and coastal waters of the Pacific Northwest, using compound relational elements to describe the broader trends across the region to understand the patterns within and across the area. This updates with new data and insights, so that informed, timely decisions can be made to support salmon recovery.

Housing crisis tracking: For example, there is a housing crisis across many parts of Canada. To address this, more houses, subdivisions, apartments, and more are being built. Currently, decisions to develop simply look for undeveloped or underdeveloped land to build on. These decisions are too simplistic to simultaneously address the housing crisis, while also addressing mental health, freshwater, stormwater, biodiversity, climate, and other crises. The system may ingest and filter data that simultaneously describes nature, people, social and cultural values, existing housing with occupancy and vacancy rates, and more to optimize development. For example, a project may, at the municipality level, ingest nature-based data about water, biomass, and biodiversity from remote sensing, on the ground sensors, people's observations, photographs, and more. It may also gather housing data from censuses, people's observations, services delivered and use (e.g., water usage, electricity) to describe vacancies. It may also ingest data about the number of people using nature-based and other services, like libraries, parks, forests, lakes, grocery stores, coffee shops, restaurants, the waterfront, beaches, and more. When, all combined, a project could identify hotspots for nature and social good with vacancies, and help direct, in a transparent and timely manner, where the best opportunities for development are that don't further degrade ecosystems, water cycles, biodiversity, flood/drought control, and mental health. Then, other projects could be repeated, for all other municipalities across provinces and Canada. When considered together in a nation-wide project, Canada could prioritize, in an informed, transparent, timely manner, where growth can be directed while maintaining and restoring other dimensions, such as freshwater resources, biodiversity, and more, which life and well-being depends on. The country wide project would use compound relational elements fed from provincial and municipal outputs to track the overall status of housing and its deficiencies, with water, nature, biodiversity and other metrics. All of these municipal to country-specific projects may then scale to all countries around the world, and considering sea level rise, may help guide the global migration of humans from low lying areas based on space and available resources without further diminishing earth's remaining ecological resources.

Although the embodiments described herein show only one method 200 with one publication 280, the inventor contemplates in an alternative embodiment that multiple projects and publications, such as at different spatial scales, variables, topics, or other layers, could be produced simultaneously or in an integrated and collaborative fashion. The display 105 would enable administrator(s) to access and work on multiple projects with a plurality of administrator(s) that produce a plurality of publications 280.

Although the embodiments described herein show that the data flow into the project after the project has become activated 216 and published 282, the inventor also contemplates that user/external data 232, 234 could flow into the project through the data input and data selection filter 236, 122, 122D, 122E, data quality checks and summaries 238, human-in-the-loop review 240, validation 242, data analysis 244, and results display 246, before activating the publication 282, 284.

Although the embodiments described herein show that the data flows into the project after it has become activated 216 and published 282, the inventor contemplates that user/external data 232, 234 could flow into the project through the input and selection filter 236, 122, 122D, 122E, data summary and quality checks 238, human-in-the-loop review 240, validation 242, data analysis 244, results display 246, administrator(s) review and interpretation 248, and produce the written or pictorial elements 250 before activating the publication 282, 284, 286.

Although the embodiments described herein show that an administrator reviews and interprets the results 248 and writes or updates the written or pictorial elements of the publication 250, with or without external insights or source/relational/compound relational elements change data 256, the inventor contemplates that these writings may be completed in part or in full by artificial intelligence, such as ChatGPT, CoPilot, Microsoft® Bing AI, and others. Additionally, AI could be used to identify and replicate studies in different areas or different topics that could relate to the administrator's current project or objectives, find new data sources, create new analytics, create new graphics, interpret results, identify relevant references in the art, identify outliers in data, without being limiting.

Although the servers 120, 121, 122, 123 are described herein as discrete servers, other combinations may be possible. For example, the four servers may be incorporated into a single server, combined in a platform, or there may be a plurality of each type of server in order to balance the server load, or other system configuration. In some aspects, the servers may be replaced with a cloud-based computing platform.

Although the embodiments described herein use a particular communication system, the inventor contemplates that other means of communication may be used for executing projects and producing publications between the devices 105, 106 and with the Internet 150, such as but not limited to, WiFi, Bluetooth, WiFi Direct, LTE, 3G, 5G, wired Ethernet, Infrared, without being limiting.

Although the embodiments described herein use a standard and accepted suite of materials and methods for project creation, the inventor contemplates that in the case where review(s) challenge existing methodologies, including data sources, variables, analyses, or other information, the system itself may need to be reviewed, audited, and updated to ensure the methods available are state of the art.

Although the embodiments described herein use data and dataset(s), the inventor contemplates various forms of data storage, arrangement, and access, including, but not limited to data tables, data frames, databases, relational and non-relational databases and data lakes, without being limiting.

Although the embodiments described herein show the administrator(s) as having indefinite control over their project and publication, the inventor contemplates that the community and/or the system, or a combination thereof, may need to override the administrator(s) decisions, such as in the case of fraud, miscommunicating results, and/or misleading statements and publications, or a plurality of other reasons.

Although the embodiments described herein describe a stand-alone system and method, the inventor contemplates that other forms of cooperation may occur with other systems, such as other existing or new publication outlets, or other or new data collection and processing systems.

The above-described embodiments are intended to be examples of the present invention and alterations and modifications may be effected thereto, by those of skill in the art, without departing from the scope of the invention, which is defined solely by the claims appended hereto.

The above-described embodiments are intended to be examples of the present invention and alterations and modifications may be effected thereto, by those of skill in the art, to any type of data-projects, science, journalism, investigations, and discovery.

Integrated systems exist to improve the efficiency and collaborative capacity of researchers to conduct research and investigations and prepare documents for publication and for publishers to prepare and review documents for potential publication. An aspect of the present invention couples data-projects and investigations with publication. Another aspect of the present invention is to provide a continuously and iteratively updating publication method and system. Another aspect of the present invention is to facilitate reproducibility in the data-publication process and outputs.

Another aspect of the present invention is to facilitate transparency in the data-publication process and outputs.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

1. An iterative system to generate a continually updating publication, the system comprising:
a publication creator populating a publication interface with a plurality of publication requirements;
a data input filter allowing a user to incorporate a user dataset in the publication;
a data selection filter allowing a user to incorporate a plurality of external datasets in the publication;
an iterative data identifier that identifies a relational element and a compound relational element embedded within the user dataset or the external datasets; and
a publication generator generating one or more written elements or one or more pictorial elements of the publication based on the plurality of publication requirements, the user dataset, and the external dataset; and
wherein the iterative data identifier continually updates the one or more written elements or the pictorial elements of the publication when the relational element or the compound relational element of the datasets is updated.

2. The iterative system of claim 1, further comprising a publication editor, wherein the publication editor reviews, validates, suggests changes or edits the user dataset once incorporated by the data input filter.

3. The iterative system of claim 2, wherein the publication editor reviews, validates, or edits the one or more written elements or pictorial elements of the publication once generated by the publication generator, and wherein the publication editor is an algorithm, an artificial intelligent system, or a human.

4. (canceled)

5. The iterative system of claim 1, wherein the plurality of publication requirements can be selected from publication format, publication font, publication style, publication length, publication authors, publication editors, publication reviewers, publication sources, user datasets, or external datasets.

6. The iterative system of claim 1, wherein the plurality of external datasets are research databases, publications, published books, government publications, patent documents, photo libraries, stories, observations, or any publicly or privately available literature.

7. The iterative system of claim 1, wherein the plurality of user or external datasets are validated by artificial intelligence, algorithm, or human administrator.

8. The iterative system of claim 1, wherein the one or more written elements are text, values, results, data or any written content of the publication, and wherein the one or more pictorial elements are graphs, maps, diagrams, figures, charts, tables, or any pictorial content.

9. The iterative system of claim 1, wherein the relational element is one or more values, results, summary statistics, year ranges, study locations, methodologies, citations, figures, text or any other piece of information, and wherein the compound relational element is one or more calculations, statistics, suites of values, or any data used to fill the relational element.

10. (canceled)

11. The iterative system of claim 1 further comprising:
a source identifier, that provides a sourcing information of the relational element, the compound relational element, the one or more written elements or pictorial elements of the publication, or any portion thereof;
wherein the source identifier identifies a source of the user dataset, external dataset, relational element, compound relational element, the one or more written elements or pictorial elements and generates the sourcing information; and
wherein the source identifier automatically updates the sourcing information when the source of the user dataset, external dataset, relational element, compound relational element, the one or more written elements or pictorial elements changes.

12. (canceled)

13. (canceled)

14. The iterative system of claim 1, wherein the publication is nested in a group of related publications, wherein the one or more written elements or pictorial elements of the publication are continually updated when the one or more written elements or pictorial elements of any member in the group of related publications are updated.

15. An iterative and coupled data-publication system comprising:
a project creator populating a project with a plurality of project requirements;
a data input and filter sourcing and validating a plurality of data into a validated dataset with at least one of the plurality of project requirements;
a data analysis and results display executor processing, analyzing, and displaying the validated dataset automatically; and
an iterative publication generator populating a publication with results and any written element generated by an algorithm, an artificial intelligent system, or a human administrator, or a combination thereof.

16. The iterative and coupled data-publication system of claim 15, wherein the project executes in tandem, or near-tandem with the publication, wherein the algorithm, the artificial intelligent system or the human administrator creates the project, wherein the plurality of data is sourced for inclusion in the project from at least one data source, wherein the data input and filter includes soliciting input from the algorithm, the artificial intelligent system or the human administrator, and wherein the publication is generated for viewing by a plurality of consumers.

17-20. (canceled)

21. The iterative and coupled data-publication system of claim 15, wherein the publication is generated for viewing by a plurality of consumers, optionally following at least one third-party review or action by the algorithm, the artificial intelligent system or the human administrator.

22. The iterative and coupled data-publication system of claim 15 further comprising an iterative publication review generator for updating status of the publication based on prompts for at least one review, wherein additional data initiates the iterative publication generator to update the publication.

23-28. (canceled)

29. An iterative and coupled data-publication method comprises:
populating a project with a plurality of project requirements;
sourcing and validating a plurality of data into a validated dataset with at least one of the plurality of project requirements;
processing, analyzing, and displaying the validated dataset automatically; and
iteratively populating a publication with results and any written element generated by the algorithm, the artificial intelligent system or the human administrator, or a combination thereof.

30. The iterative and coupled data-publication method of claim 29 further comprising:
executing the project in tandem, or near-tandem with the publication; and
creating the project by the algorithm, the artificial intelligent system or the human administrator.

31. (canceled)

32. The iterative and coupled data-publication method of claim 29 further comprising:
sourcing the plurality of data for inclusion in the project from at least one data source; and
soliciting input from the algorithm, the artificial intelligent system or the human administrator.

33. (canceled)

34. The iterative and coupled data-publication method of claim 29 further comprising:
generating the publication for viewing by a plurality of consumers; and
updating the status following at least one third-party review or action by the algorithm, the artificial intelligent system or the human administrator.

35. (canceled)

36. The iterative and coupled data-publication method of claim 29 further comprising updating a status of the publication based on prompts for at least one third-party review.

37. The iterative and coupled data-publication method of claim 36 further comprising initiating the update of the publication in response to the status change of the publication.
